(19) United States
(12) Patent Application Publication
(10) Pub. No.: US 2002/0065769 A1
(43) Pub. Date: May 30, 2002

(54) Method and apparatus for processing unmet demand

(76) Inventors: Roberto Irribarren, Fremont, CA (US); Michael D. Bishop, Mill Valley, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/002,555

(22) Filed: Nov. 1, 2001

Related U.S. Application Data
(63) Continuation of application No. 60/250,925, filed on Nov. 30, 2000.
(60) Provisional application No. 60/260,066, filed on Jan. 5, 2001.
(60) Provisional application No. 60/302,520, filed on Jul. 2, 2001.

(51) Int. Cl. G06F 17/60

(52) U.S. Cl. 705/37

(57) ABSTRACT

According to one embodiment, the meeting of buyer demand that was unmet in prior bidding cycles in an on-line bidding transaction is provided. In one such embodiment, a method includes determining that a price for a quantity of business offered by at least one vendor and a price by at least one buyer for the quantity of business do not match during at least one prior bidding cycle in an on-line bidding transaction. The method also includes determining a difference between the price by the at least one vendor and the price by the at least one buyer. Additionally, the method includes generating a new bidding cycle in the on-line bidding transaction upon determining that the difference is within a range.

### RELATED APPLICATIONS

This is a continuation of the following: U.S. Provisional Patent Application Serial No. 60/250,925, entitled “Method and Apparatus for Processing Unmet Demand” filed Nov. 30, 2000; U.S. Provisional Patent Application Serial No. 60/260,066, entitled “Method and Apparatus for Processing Unmet Demand” filed Jan. 5, 2001; and U.S. Provisional Patent Application Serial No. 60/302,520, entitled “Method and Apparatus for Processing Unmet Demand” filed Jul. 2, 2001.

### FIELD OF THE INVENTION

The present invention relates to electronic sales applications using electronic networks. In particular, the present invention relates to a method and apparatus for processing unmet demand between vendors and buyers in a bidding system.

### BACKGROUND

The advent of the Internet and electronic processing of orders has spawned many schemes for electronically linking buyers to vendors, creating electronically mediated auctions, bid-ask systems and other electronic business transactions.

The business models so far have been to optimize the bidding or auction between one vendor of a specific product and several potential buyers. In one business approach, a third party Internet company, like OnSale, offers, for sale by auction, surplus products from established manufacturers. EBay offers a similar approach to consumers trying to sell to other consumers' collectible or used products. In another business approach, manufacturing or distribution companies, like Ingram, use auction software on their own web sites to allow purchase of excess inventory to only a selected group of clients, thereby protecting their traditional channels of distribution.

Stephen J. Brown (U.S. Pat. No. 5,794,219) describes a method of conducting an on-line auction with bid pooling in which registered bidders can aggregate their bids into a specific group to bid together for a specific auction item electronically and remotely through a series of computers hooked to an internet. Each bid contains a designation of the group to which the bid should be added. Bids that then aggregate to the highest amount for given auction items win the bid. The system is geared toward auctions of well-known art works and the likes in which bidding groups are widely used.

In another approach, a buyer posts a price at which he would buy a service and the vendors can accept or reject the offer. Jay Walker et al. (U.S. Pat. No. 5,794,207) (later Priceline.com) describes a commercial network system designed to facilitate buyerdriven conditional purchases. In this system, a buyer makes a binding bid electronically, which is then transmitted to vendors who have the opportunity to accept or reject an offer. This is an electronic version of a virtually identical business model promoted by an earlier company on which several press reports were published. (Laura Del Rosso, “Marketel Says it Plans to Launch Air Fare ‘Auction’ in June” Travel Weekly, Apr. 29, 1991 and Jeff Pelline, “Travelers Bidding on Airline Tickets: SF Firm Offers Chance for Cut-rate Fares”, San Francisco Chronicle, Section A4, Aug. 19, 1991). This system clearly depends upon a bid on a product or service by a specific individual buyer, who then secures his order at his bid price by providing a credit card authorization. The bid is then broadcast electronically to multiple vendors who can choose to either accept or reject the bid. The patent goes on to teach algorithms, forms, data networks, financial authorization systems, encryption and internet configurations to accommodate this business model.

Finally Joseph Giovannoli (U.S. Pat. No. 5,758,328) describes a computerized quotation system in which a network of buyers and a network of vendors is contained in a processing unit. Individual buyers submit requests for quotes with certain filters, such as time of delivery, quality, etc. Based on the filters and information contained about the vendors, the computer selects and broadcasts the request for quotes to appropriate vendors who then respond. Vendor responses that meet the quote filters are passed either directly to the buyer or into a database to which the buyer has access. The buyer then completes a chosen transaction.

In a completely different paradigm, driven by the need to compete against larger rivals, small business have banded together to form buyers' groups in which buyers aggregate their demand in order to achieve better pricing. Perhaps best known of these is the group of hospitals which band together demand in order to obtain hospital chain volume and pricing from medical products companies. Such Group Purchasing Organizations (GPOs) combine buyers needs for an agreed series of products, present the request for quote to a limited number of approved providers in the group, and theoretically receive better prices for higher volume commitment than their individual members could obtain. However, the GPOs often lack the clout they need with the vendors because the buyers, who often prefer branded products or services from specific suppliers, are not obligated to buy from the GPOs selected vendor.

In one such system, the vendors submit an asking price for a given quantity of business, while the buyers submit bids for a given quantity of business as well as the vendors from which the buyers are willing to buy such business. Subsequently, vendors and buyers are matched based on the pricing and vendor selection.

While all of the above systems greatly enhance the fluidity with which buyers and vendors can come together in various ways, agree on price, and conclude a transaction, for those systems that lack the ability to match buyers to sellers when such parties are close to an agreement concerning the price. In other words, such systems lack the ability to resolve relatively small disparities in price between a buyer and a seller. In particular, conventional auctioning systems treat a price disparity of $0.01, $1 and $1000 equally, as any such price disparity results in not consummating the sales transaction between the buyer and the seller.

### SUMMARY

According to one embodiment, the meeting of buyer demand that was unmet in prior bidding cycles in an on-line bidding transaction is provided. In one such embodiment, a method includes determining that a price for a quantity of business offered by at least one vendor and a price by at least one buyer for the quantity of business do not match during at least one prior bidding cycle in an on-line bidding transaction. The method also includes determining a difference between the price by the at least one vendor and the price by the at least one buyer. Additionally, the method includes generating a new bidding cycle in the on-line bidding transaction upon determining that the difference is within a range.

### BRIEF DESCRIPTION OF THE DRAWINGS

FIG. 1 is a block diagram of one embodiment of an open market network;

FIG. 2 is a block diagram of one embodiment of an intermediary server;

FIG. 3 is a flow diagram of one embodiment of the operation of an open market sales transaction;

FIG. 4A is a flow diagram of one embodiment of a request for future trade process;

FIG. 4B is a flow diagram of one embodiment of a buyer pooling process;

FIG. 4C is one embodiment of a table illustrating the type of information stored during an exemplary trade;

FIG. 5A is a flow diagram of one embodiment of a process for combining multiple request for quote;

FIG. 5B is one embodiment of a table illustrating the type of information stored after a combined request for quote;

FIG. 5C is one embodiment of a graphical representation of a vendor trade curve;

FIG. 6A is a flow diagram of one embodiment of a vendor pooling process;

FIG. 6B is one embodiment of a table illustrating the type of information stored after the vendor pooling phase;

FIG. 6C illustrates one embodiment of tier pricing entered by a vendor;

FIG. 6D is one embodiment of a graphical representation of a vendor trade curve combined with tier pricing;

FIG. 7A is part of a flow diagram of one embodiment of bidding state generations;

FIG. 7B is the remainder of the flow diagram of bidding state generations;

FIG. 7C illustrates the initial satisfaction status of the buyers during a bidding state;

FIG. 7D illustrates a working winning pool that fails;

FIG. 7E illustrates the satisfaction status of the buyers after the processing for the working winning pool of FIG. 7D is complete;

FIG. 7F illustrates a working winning pool that succeeds;

FIG. 7G illustrates the satisfaction status of the buyers after the processing for the working winning pool of FIG. 7F is complete;

FIG. 7H illustrates a second working winning pool that succeeds;

FIG. 7I illustrates the satisfaction status of the buyers after the processing for the working winning pool of FIG. 7H is complete;

FIG. 7J illustrates the current bidding state;

FIG. 8 is a flow diagram of the close trade phase at process block 390;

FIGS. 9A-9H illustrate exemplary screen snapshots of exemplary pages displayed at buyer clients; and

FIGS. 10A-10I illustrate exemplary screen snapshots of exemplary pages displayed at vendor clients;

FIG. 11 is a flow diagram of one embodiment of meeting the unmet demand of buyers for a quantity of business that was not satisfied in the prior bidding cycles of an on-line bidding transaction;

FIG. 12 is a flowchart diagram of one embodiment of the new bidding cycle generated at process block 1112; and

FIG. 13 is a flowchart diagram of another embodiment of the new bidding cycle generated at process block 1112.

### DETAILED DESCRIPTION

In the following description, numerous details are set forth. It will be apparent, however, to one skilled in the art, that the present invention may be practiced without these specific details. In other instances, well-known structures and devices are shown in block diagram form, rather than in detail, in order to avoid obscuring the present invention.

Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general-purpose computer selectively activated or reconfigured by a computer program stored in the computer. Such a computer program may be stored and/or transmitted in a machine readable storage medium, such as, but is not limited to, any type of read only memory (ROM); random access memory (RAM); magnetic disk storage media; optical storage media; flash memory devices; electrical, optical, acoustical or other form of propagated signals (e.g., carrier waves, infrared signals, digital signals, etc.); etc.

The flow diagrams and displays presented herein are not inherently related to any particular computer or other apparatus. Various general-purpose systems may be used with programs in accordance with the teachings herein, or it may prove convenient to construct more specialized apparatus to perform the required methods. The required structure for a variety of these systems will appear from the description below. In addition, the present invention is not described with reference to any particular programming language. It will be appreciated that a variety of programming languages may be used to implement the teachings of the invention as described herein.

The instructions of the programming language(s) may be executed by one or more processing devices (e.g., processors, controllers, central processing units (CPUs), execution cores, etc.).

### OVERVIEW

A detailed description for an open market network is provided in co-pending U.S. patent application Ser. Nos. 09/410,490 and 09/409,836 both filed Sep. 30, 1999, U.S. provisional patent application Ser. No. 60/161,789 filed Oct. 27, 1999, PCT patent application PCT/U.S. 00/04814 mailed Feb. 22, 2000 and U.S. provisional patent application Ser. Nos. 60/250,925, filed Nov. 30, 2000; 60/260,066, Jan. 5, 2001; 60/302,520, filed Jul. 2, 2001, all incorporated herein by reference. Described therein are methods, systems, databases, electronic networks, and other hardware and software which allow electronic aggregation of multiple buyers needs, presentation of the aggregate buyers needs anonymously to one or more vendors to request quotes, and optimization of numerous selling terms to the maximum benefit of the buyers are provided. While a brief summary of what is described therein is provided below, a more detailed explanation is provided later herein.

According to one embodiment described therein, buyers' requests are aggregated in order to receive enhanced business terms. Such aggregation enables the group of buyers to accept an arrangement that is superior than they would otherwise receive if they were negotiating individually. In one embodiment, the identity of the group of buyers remains anonymous without compromising quality, service, preferred vendors or other value considerations.

An intermediary electronically aggregates and transmits binding multiple buyers' commitments in the form of quote requests to buy specified products (e.g., branded or commodity) or services to one or more vendors. A specific buyer may initiate a quote request that gets posted anonymously to allow other buyers to join in or the intermediary can post regular quote requests based on an optimization of the preferences of the buyers' community and the demand based on prior trades. In one embodiment, the intermediary is “trusted” (e.g., known to both the buyers and the sellers). Further, the intermediary may have entered into legally binding agreements with the buyers and/or the sellers requiring them to complete sales transactions entered into using the system.

In a further embodiment described therein, quotes are optimized to match all of an individual buyer's preferences in order to achieve a lowest price bid for the largest volume of purchased product. Further, communication between the intermediary and the buyer regarding the economics of changing certain preferences (e.g., quality levels, acceptable vendors, etc.), and between the intermediary and the vendor providing price bid versus volume committed information to the vendor can be provided. It should be understood that the term product as used herein is defined to include something that is sold; as such, the term product can include a physical item(s), a service(s), or both.

Any given trade on the open market system can involve a single type of product or a lot. Where a lot is defined as a union of lot items within a trade. A lot item is a specific product or a single product type (i.e., where a product type defines a class made up of specific products). For example, a lot item may be ENERGIZER® AA batteries (a specific product) or AA batteries (a product type that defines a class made up of, for example, ENERGIZER®, DURACEL®, EVERYREADY®, etc.). What specific products are included in the class defined by a lot item will typically be defined in terms understood within a particular industry by both buyers and sellers. With regard to lots, typically a lot will only include lot items having a common feature or theme (e.g., a common application). A natural lot would be batteries, having lot items including AA size batteries, AAA size batteries, C size batteries, etc. Another natural lot would be a flashlight and the batteries suitable for powering the flashlight, as the lot items (the flashlight and the batteries) are suitable for a common application, even though they may be manufactured by separate entities. However, lots need not have a common feature or them, but may include anything a buyer wishes to include, and may also be defined by what a vendor will include. The term “buyer purchase interest” is defined herein to refer to trades involving a single specific product/service, a single product/service type, and a lot (i.e., In a trade involving a single specific product, the buyer purchase interest is the single specific product; In a trade involving a single product type, the buyer purchase interest is the single product type; and in a trade involving a lot, the term buyer purchase interest would refer to the lot). However, the remainder of this detailed description uses the term product to simplify understanding of the invention.

One issue with the systems described therein is the lack of committed purchases for those purchases whose asking and bidding price are consider close. For example, in certain trade scenarios, the vendors have an asking price per product of $100, while the buyers have an asking price per product of $99. Realistically, in a negotiation process in which the vendors and sellers are face to face in a negotiations session, such a small amount of disparity in price could be resolved through a compromise by both or either parties. For example, the parties could split the difference and settle on a price of $99.50/product. Accordingly, the current systems described therein consider the price disparity of $0.01, $1 and $1000 between the vendors and the buyers equally, as the negotiation process is completed without a committed purchase.

According to one embodiment of the present invention described herein, the meeting of buyer demand that was unmet in prior bidding cycles in an on-line auction is provided. In one such embodiment, a method includes determining that a price for a quantity of business offered by at least one vendor and a price by at least one anonymous buyer for the quantity of business do not match during at least one prior bidding cycle in an on-line auction. Additionally, a difference between the price by at least one vendor and the price by the at least one anonymous buyer is determined. Additionally, the method includes generating a new bidding cycle in the on-line auction upon determining that the difference is within a pre-agreed range.

The phrase “manually selecting” is used herein to refer some form of user action (e.g., clicking a radio box using an input device such as a mouse, providing some sort of voice command to a machine capable of voice recognition, calling the intermediary on the phone, sending a fax, etc.). Of course, techniques other than manually selecting from a list could be used for designating the unacceptable/acceptable vendors (e.g., a free form listing by the buyers, a select all vendors as acceptable feature, etc.).

While embodiments of the invention will be described with reference to the open market system described above and later herein, it is understood that the invention is applicable to any bidding and/or auction type market system. In addition, in the example above it is assumed that each vendor sells one specific product of a product type. Thus, excluding or including a vendor is sufficient. However, it is understood that for different markets a vendor may sell more than one specific product of the same product type. In these situations, the including and excluding can be done by specific product (that may or may not be part of a lot) and, if chosen, by vendor. Thus, the including and excluding is a selection between purchasing options.

### FURTHER DESCRIPTION

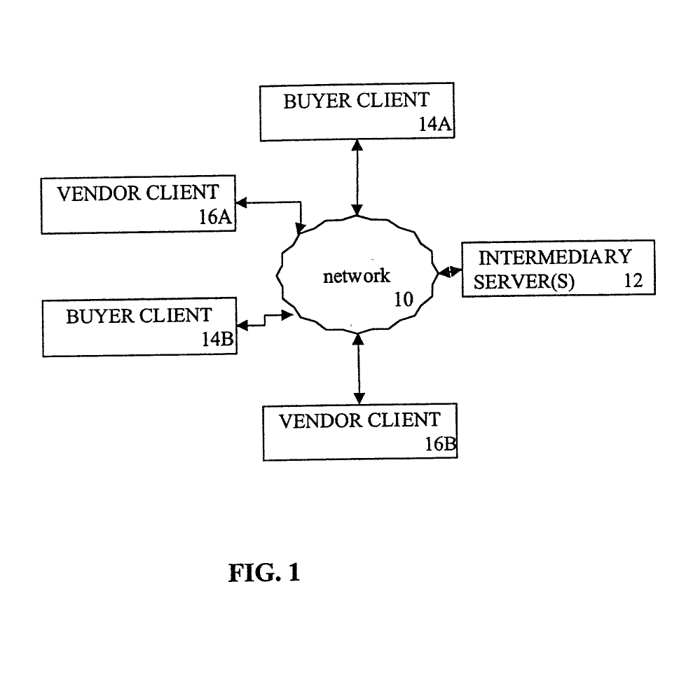

FIG. 1 is a block diagram of one embodiment of an open market network. The open market network includes a network 10, an intermediary server 12, buyer clients 14A and 14B, and vendor clients 16A and 16B. In one embodiment, network 10 comprises the Internet. However, in other embodiments, network 10 is not limited to the Internet. The teachings disclosed herein might be applied to various networks, data and document storage and archival facilities, or other types of client/server systems that have documents or other information available upon request.

According to one embodiment, intermediary server 12 is coupled to network 10 and is able to respond to requests from buyer clients 14 and vendor clients 16 via network 10. In one embodiment, the received requests are associated with the Internet (or World Wide Web (the WWW)). In such an embodiment, intermediary server 12 acts as a WWW server. That is, clients are directly coupled to a local area network (LAN) or wide area network (WAN) and “serve” data, such as images or other multi-media objects that they capture or create to intermediary server 12.

Further, intermediary server 12 establishes certain sales terms (e.g., price) and optionally executes the sales transactions between buyer clients 14 and vendor clients 16 as will be described in more detail below. In one embodiment, intermediary server 12 uses a hypertext transfer protocol (“HTTP”) to communicate over network 10 with the clients; such clients also communicate with intermediary server 12 using the hypertext transfer protocol. Thus, intermediary server 12 and these clients act as an HTTP server and HTTP clients respectively.

Buyer clients 14 communicate with intermediary server 12 via network 10. According to one embodiment, buyer clients 14 include a program (e.g., a browser) that permits users to access documents over network 10 that are located on intermediary server 12. In one embodiment, users at buyer clients 14A and 14B transmit requests to intermediary server 12 that include requests to purchase various products and services. Vendor clients 16 also include a browser that permits users to access documents that are located on intermediary server 12 via network 10. Users at vendor clients 16A and 16B transmit requests to intermediary server 12 that include requests to supply the requests of users at buyer clients 14A and 14B.

The clients in the system will typically include a client processor and a memory and a computer readable medium, such as a magnetic or optical mass storage device, and the computer readable medium of the client contains computer program instructions for receiving data from intermediary server 12 and for storing the data at the client. One of ordinary skill in the art will appreciate that additional buyer and vendor clients may be coupled to network 10.

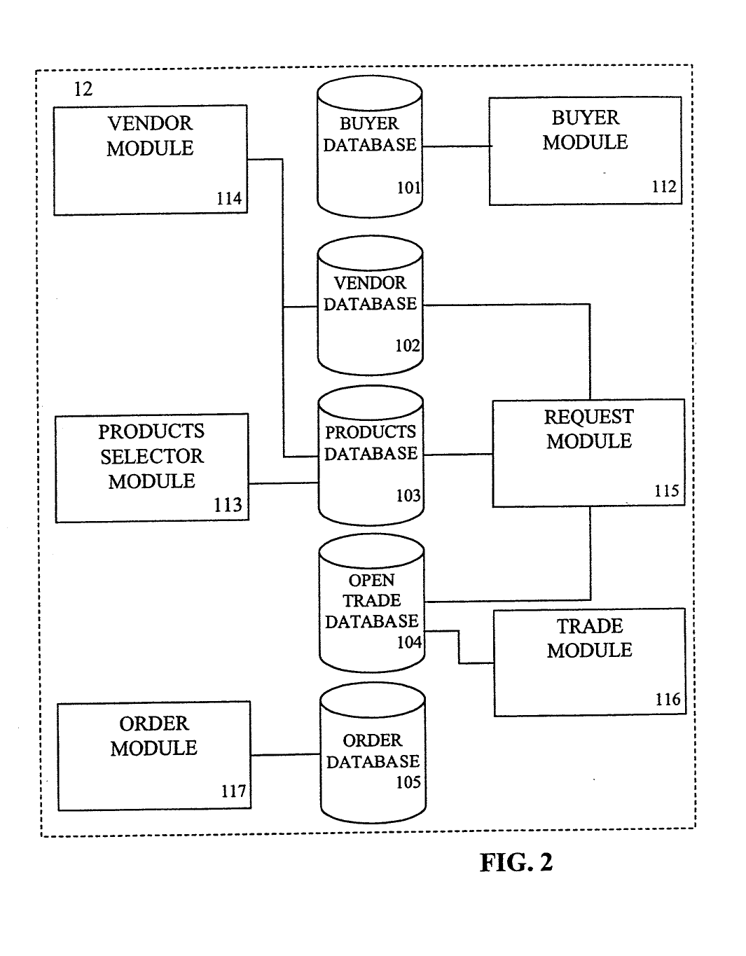

FIG. 2 is a block diagram of one embodiment of an intermediary server 12. Intermediary server 12 includes buyer database 101, vendor database 102, products database 103, an open trade database 104 and order database 105. Although databases 101-105 have been described as separate databases, one of ordinary skill in the art will appreciate that databases 101-105 may be implemented as a single database. In addition, intermediary server 12 includes a buyer module 112 coupled to buyer database 101, a products selector module 113 coupled to products database 103, and a vendor module 114 coupled to vendor database 102 and products database 103. Further, a request module 115 is coupled to vendor database 102, products database 103 and open trade database 104; an trade module 116 is coupled to open trade database 104; and an order module 117 is coupled to order database 105.

Buyer module 112 qualifies and manages potential buyers based on a list of criteria stored in buyer database 101. According to one embodiment, buyer database 101 includes company information, and a list of users and related passwords for persons authorized to use intermediary server 12. In one embodiment, a qualified buyer at a buyer client 14 may enter the system via a buyer web portal that is customized for each buyer.

Product selector module 113 manages product database 103. According to one embodiment, product selector 113 lists products and/or services by one or more criteria, such as category, description, related vendor, interested buyers, etc. Users at buyer clients 14 may record their qualified list of vendors by products or services based on their own experience and/or available characteristics. In addition, buyer client 14 users may enter feedback to be shared with other buyers on their experiences with these vendors. In one embodiment, such feedback will create a vendor rating based on several criteria such as quality, time delivery, service, product effectiveness and safety. The acceptable list of vendors may also be created automatically by the system based on previous trade activities. The notification of future trades may be based on each buyer's selection of specific categories and products.

Vendor module 114 manages vendors' information stored in the vendor database 102. In addition, vendor module 114 may be configured to provide a list of products or services offered by the vendors as stored in product database 103. In one embodiment, a vendor at vendor client 16 may enter the system via a vendor web portal that is customized for each vendor.

According to one embodiment, request module 115 posts notifications of future trades on each buyer client 14 in order to request qualified buyers to submit their request for quote by a certain date. A future trade notification may describe a particular product or service, the list of all vendors, the timing of the delivery (e.g., by a certain date, over a period of time, etc.), and other related terms. In one embodiment of the invention a given organization can instantiate multiple buyers for the same trade. For example, a given organization could create multiple buyers that each submits a different request for quote. While in one embodiment of the invention a given organization can submit multiple request for quotes through multiplier buyers for the same trade, in alternative embodiments each organization is limited to creating one buyer for a given trade.

According to one embodiment, each buyer is requested to post a quantity of business and the first selection of vendors. The posted information is used by vendors to generate a pre-cycle bid. The pre-cycle bids are used by the buyers to select various vendors that are acceptable to participate in the current trade. A buyer is committed to purchase the initial requested volume for the traded product if any vendor designated as acceptable provides a bid below a maximum price set by the buyer. Of course, in alternative embodiments of the invention, the agreed upon terms may be used for other purposes (e.g., the agreed upon terms may form a memorandum of understanding according to which the parties agree to make their best efforts to agree on the necessary remaining terms to complete the transaction). The transaction price may be a unit purchase price. Alternatively, the transaction price may be a total purchase price that may include additional costs such as installation charge and service fee. The buyer request page allows a buyer to quickly update an acceptable vendor list by displaying the list of all vendors offering a particular product, previously selected vendors, the last bid price by these vendors, a buyers community rating hyperlink and previous comments entered by the buyer.

According to a further embodiment, request module 115 aggregates all of the volume of the buyers by group of acceptable and/or potential vendors into open trade database 104. In addition, request module 115 posts Request for Quote (RFQ) at each selected vendor client 16. In one embodiment, the RFQ indicates, for each product, the total quantity being requested, the quantity that the specific vendors have been selected for, the delivery timing and the anonymous profile of the group of buyers. The profile may include data on different terms requested (e.g., shipping and geographical location). The RFQ may also request additional information (e.g., different pricing breakdown between purchasing the products, installing the products, servicing the products, etc.). The RFQ will specify a time by which the vendors must respond.

Trade module 116 manages and posts the trade status on the applicable buyer clients 14 and vendor clients 16. According to one embodiment, the trade is implemented in a format that shows each vendor the potential order volume it will receive with the existing price quote as compared to the maximum volume from all the buyers to whom the vendor could be acceptable. In addition, the total volume of the trade may be displayed to the vendor.

Vendors may lower their bid price based on the received information during the trade period. The process may be based on a non-disclosed maximum price set by each buyer and their list of acceptable vendors. This type of trade may also be displayed to each buyer indicating the lowest quoted price from the group of acceptable vendors as well as the lowest price outside that group. According to one embodiment that allows for buyer interactivity with preserved commitment in the real time bidding phase, a buyer may decide during the open trade to add another vendor to their qualified list if that vendor has a lower quoted price, increase their quantity, increase their price, etc.

In addition, trade module 116 closes the trade at the expiration of an allotted period of time. In addition, trade module 116 may verify whether the quotes from vendors of acceptable products are below the maximum price requested by each buyer, and select an acceptable vendor with a product with the lowest price for each group of buyers. Further, trade module 116 may electronically notify the buyers and vendors of the outcome of the trade and post the results at respective buyer clients 14 and vendor clients 16.

Alternatively, other auction formats may be used. For instance, a progressive auction format may be used that awards the orders at different prices depending on the quantity level bid by each buyer. In a progressive auction, for example, the lowest bidder is awarded the aggregated volume at a final bid price after the auction is closed. In addition, higher quantity buyers may receive an additional discount from the final bid price while lower quantity buyers could be charged a compensating premium over the final bid price.

Order module 117 manages order database 105 and its contracts with the chosen vendors and successful buyers. According to one embodiment, an order status is posted at the respective buyer clients 14 and vendor clients 16. Although intermediary server 12 has been described with respect to a particular embodiment, one of ordinary skill in the art will appreciate that intermediary server 12 may be configured using various other techniques.

Various database architectures (object oriented database(s), relational database(s), hybrid of object oriented/relational database(s), etc.), combined or separately, can be used to implement the invention. For example, one skilled in the art may choose to employ a multi-tier architecture design, by designing a system with a Web Server System, to be connected to an Application Server System, which in turn connects to a Database System. The system can be implemented using a variety of techniques, including well-known techniques. For example, the intermediary server 12 may include an automated network router, such as CISCO's™ Local Director, coupled to a set of application servers (such as IBM'S™ WebSphere, NETSCAPE™ Fastrack, or Apache), coupled to an database system (e.g., ORACLE®) that may include a set of database servers coupled to a persistent data store (e.g., a set of disk arrays).

More particularly, according to one embodiment the application servers would include business logic and remote business objects. The business logic may be implemented in a variety of different languages (e.g., Java, C++, C application program interface (C API), etc.). The remote business objects may include vendor, buyer, item, bid, and trade objects. The remote business objects may be implemented using a variety of different techniques (e.g., as object/relational mapping, Enterprise JavaBeans, Common Object Request Broker Architecture (CORBA) objects, etc).

In addition, the database servers would include data access components and a distributed access manager. The data access components may be provided in a variety of different products (e.g., TopLink, RogueWave, Oracle JBOs, etc.) using a variety of different languages (e.g., Java, C++, C API, etc.). The distributed access manager may be provided in a variety of different products (e.g., Tuxedo, RMI, Visigenix, lona, BEA, etc.) and implemented using a variety of different techniques (e.g., as object/relational mapping, Enterprise JavaBeans, CORBA objects, etc).

The persistent data store may include vendor/buyer profiles, product catalogs, system registration and trades information. Further, the persistent data store may be implemented in a variety of different products (Oracle, Sybase, Informix, Gemstone, Centura, ODI ObjectStore, etc.) using a number of different structures (e.g., a database, flatfile, memory based system, file system, etc).

Moreover, embodiments of the present invention can be incorporated into systems and methods that allow for buyer pooling and aggregation, as described in co-pending U.S. patent application Ser. No. 09/409,836 filed on Sep. 30, 1999, titled “Method and Apparatus for Aggregating Vendor Sales and Bids in an Open Market Network.” Such buyer pooling and aggregation includes electronic aggregation of multiple buyers' needs, presentation of the aggregate buyers' needs anonymously to one or more vendors to request quotes and optimization of numerous selling terms to the maximum benefit of the buyers.

However, embodiments of the invention are not limited to the open market sales transactions as described above, as any other type of sales transaction process that provides at least one bidding cycle for the vendors and the buyers can be employed in conjunction with embodiments of the invention. In particular, embodiments of the invention can be incorporated into an auctioning system wherein there is a single vendor to a set of one or more buyers, which have engaged in at least one prior bidding cycle.

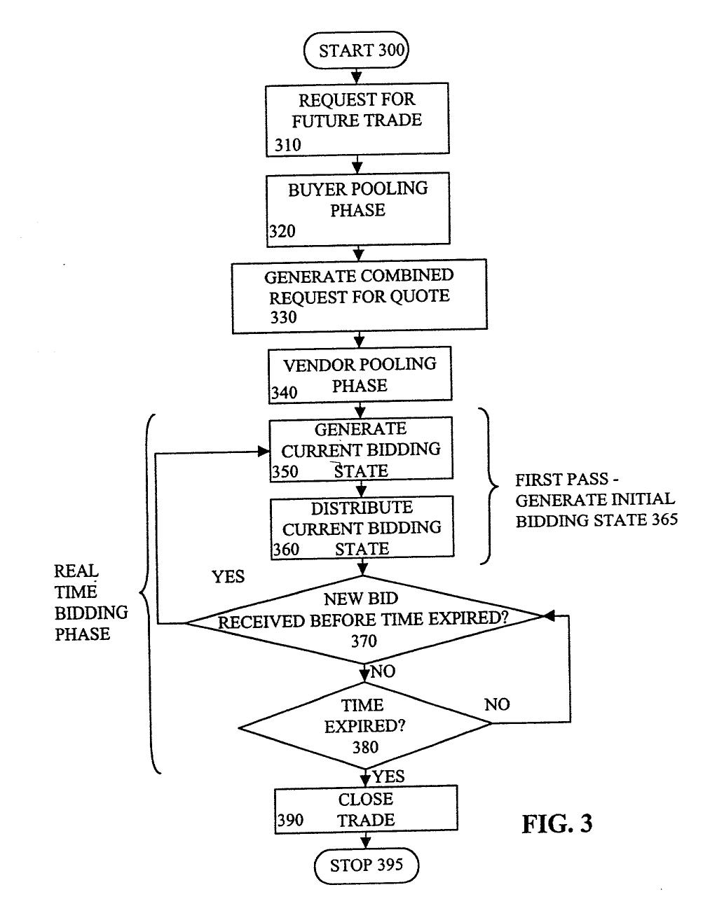

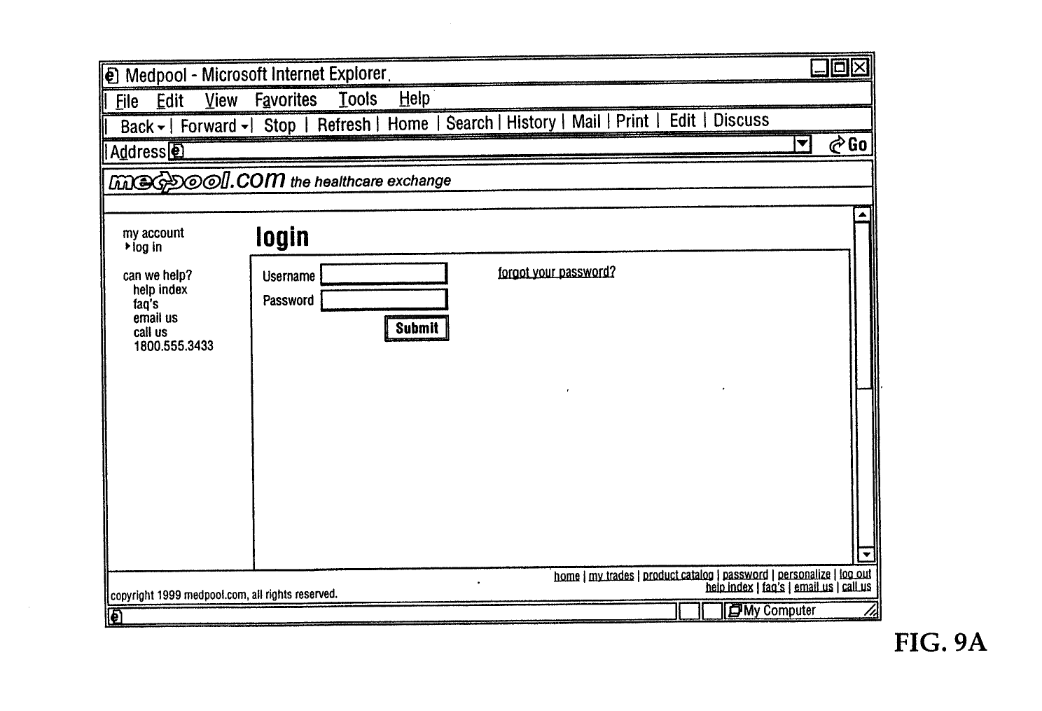

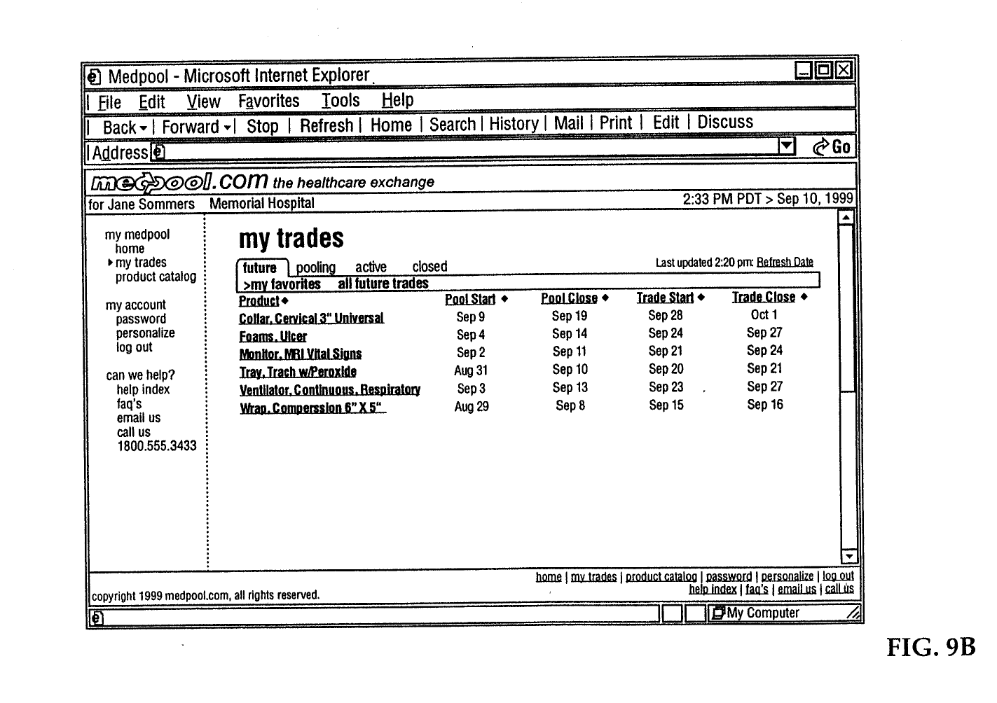

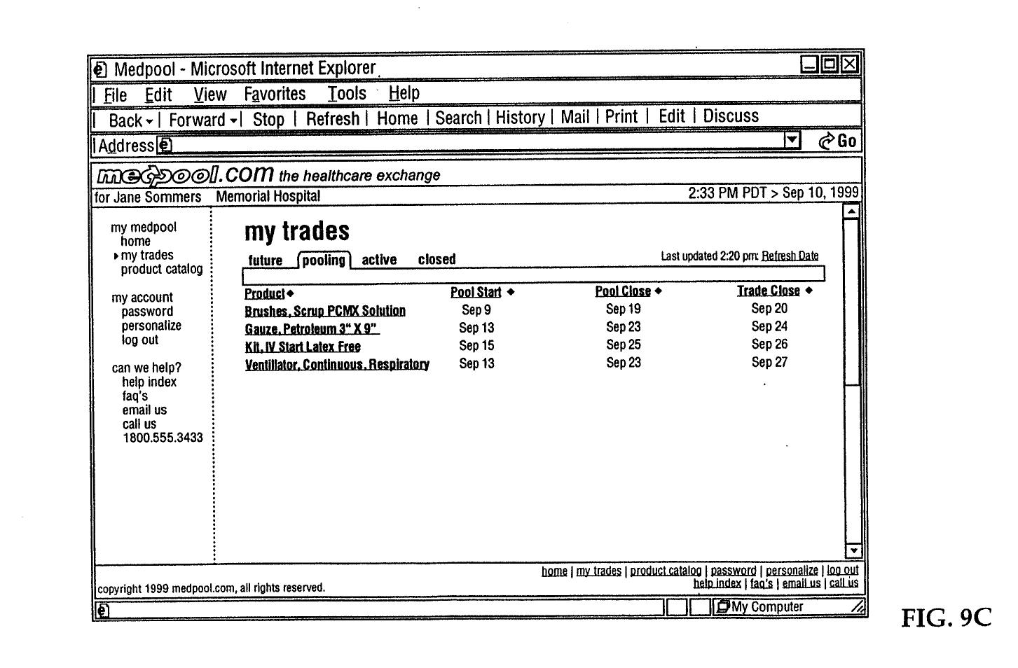

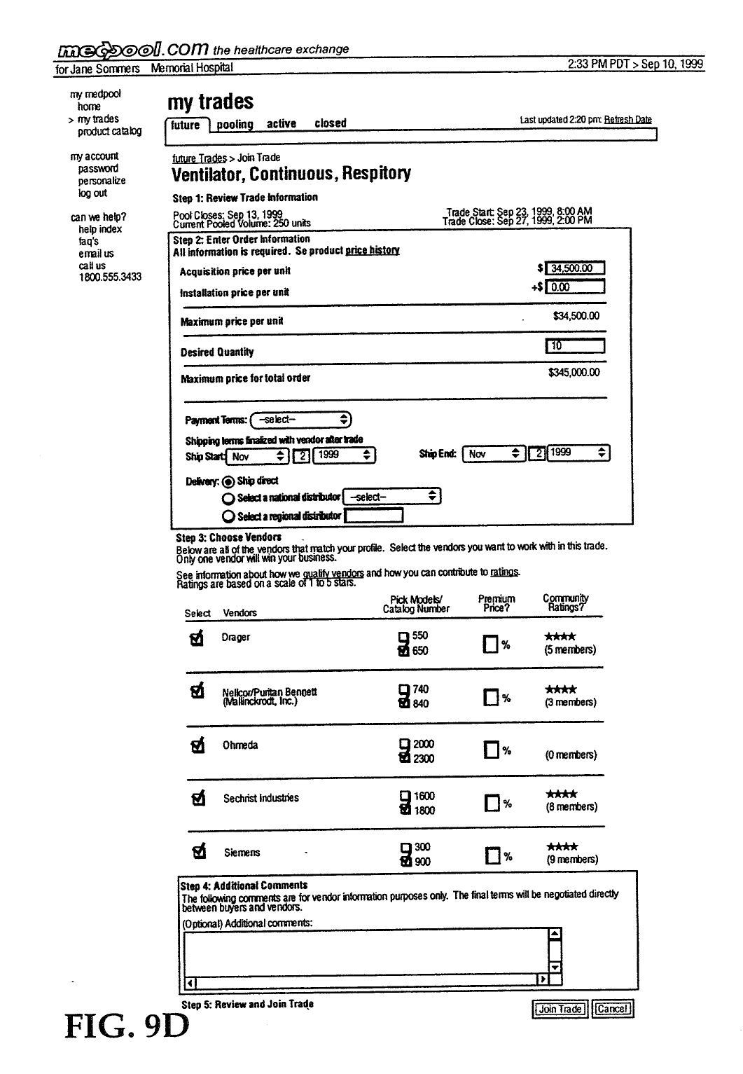

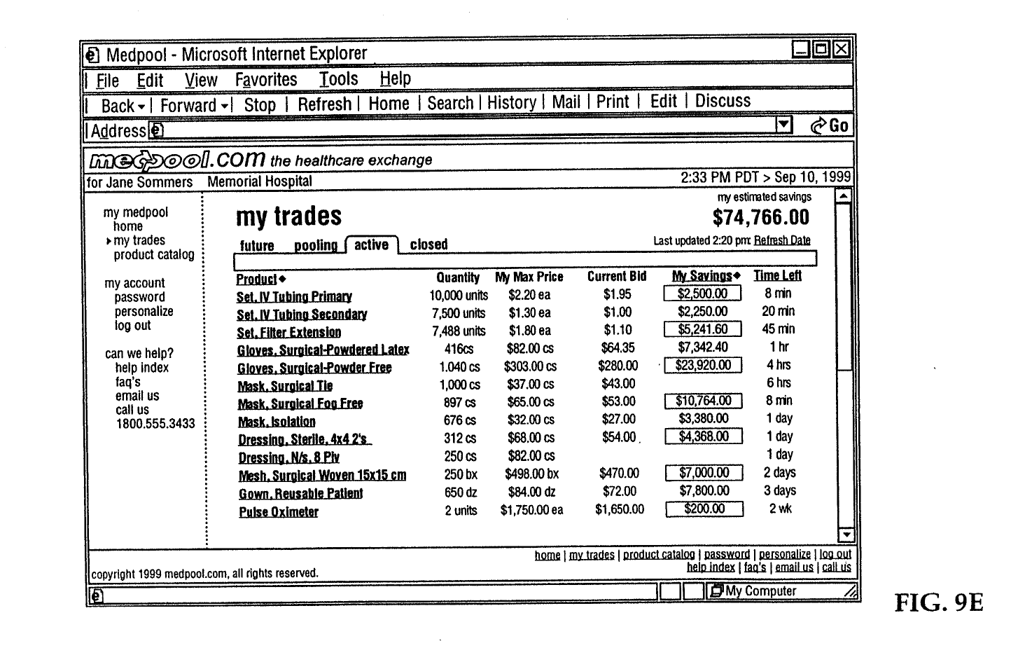

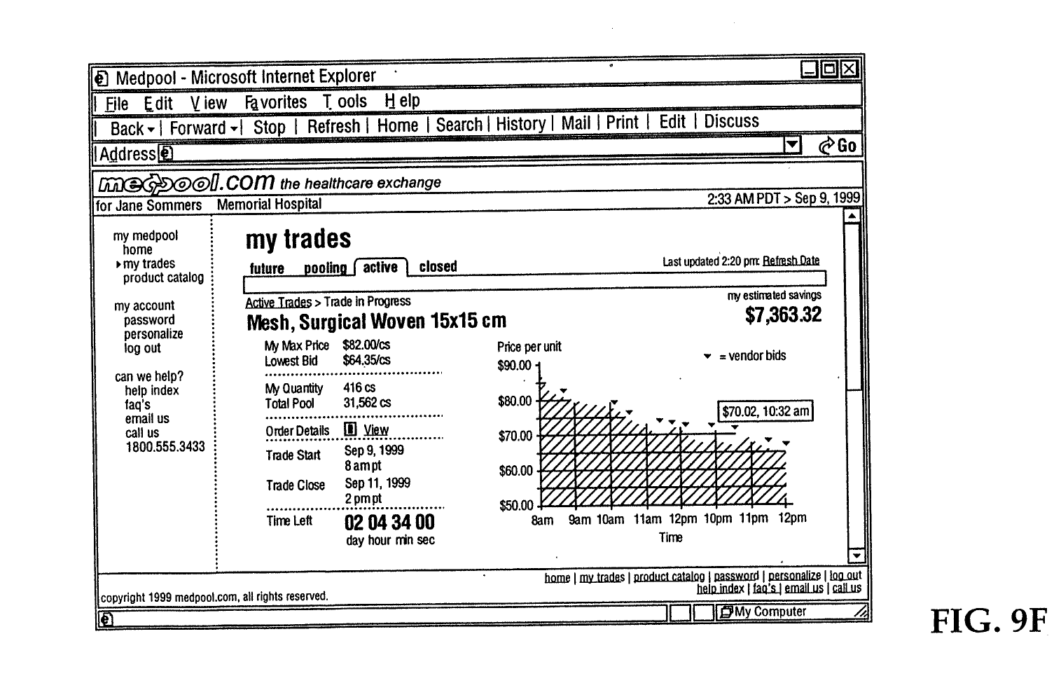

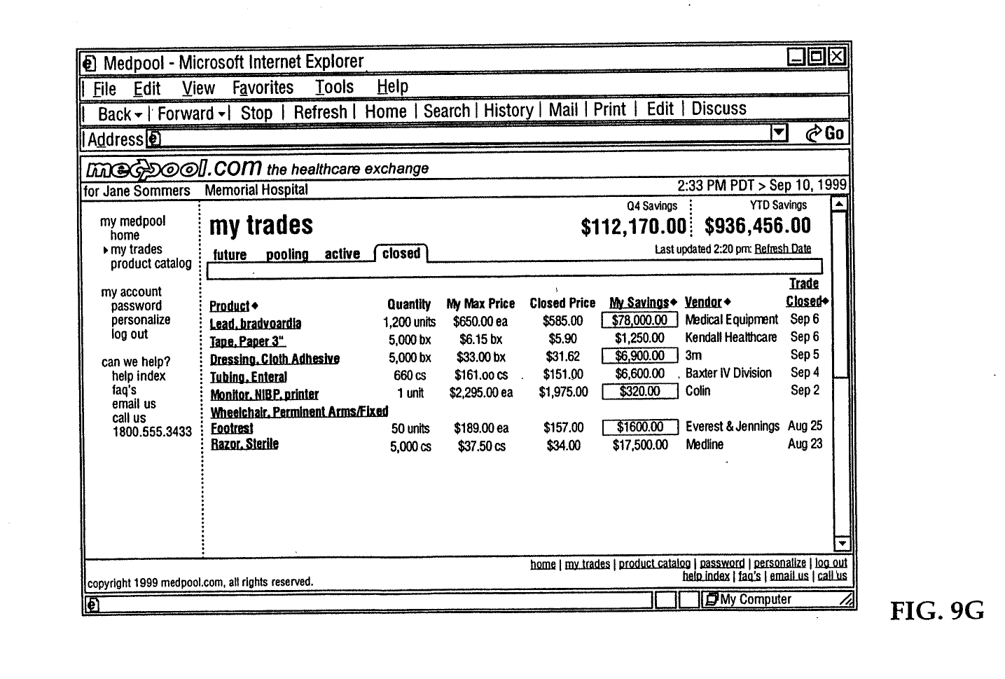

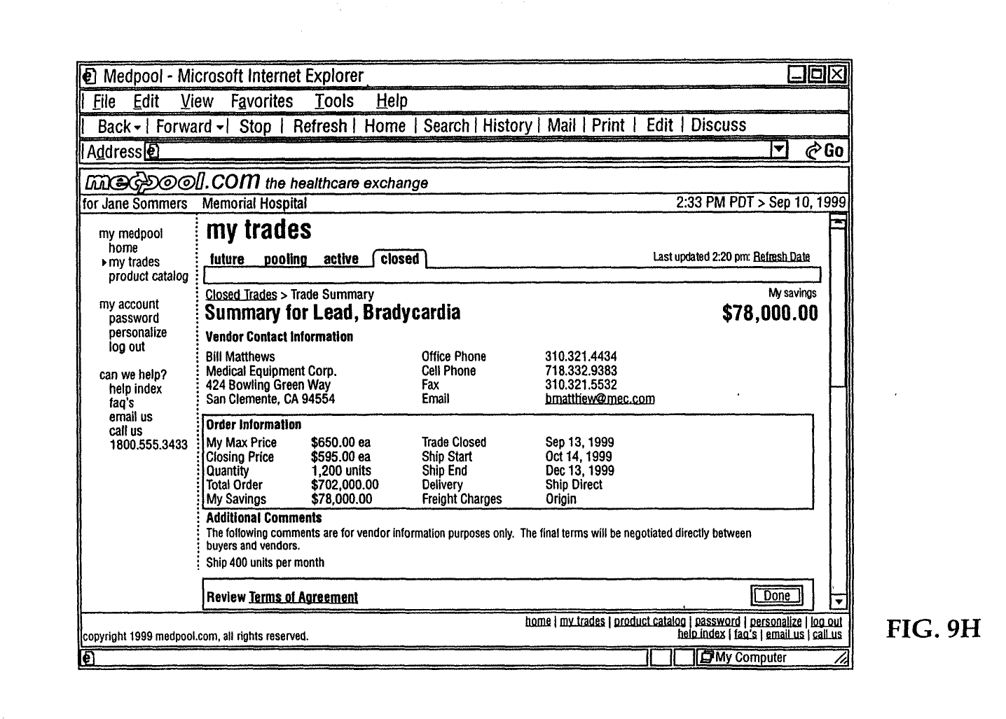

FIG. 3 is a flow diagram of one embodiment of the operation of an open market sales transaction. FIGS. 9A and 9B illustrate an embodiment of a screen shot where buyers and/or sellers log in. At process block 310, a request for a future trade is initiated. In one embodiment, a buyer client 14 and/or the intermediary server 12 may initiate trades (for example, the intermediary server may initiate a trade automatically at periodically scheduled periods, at the suggestion of one or more vendors, etc.). Trades initiated by intermediary server 12 may be initiated at predetermined intervals (e.g., weekly, monthly, quarterly, etc.). hi such an embodiment, intermediary server 12 automatically sets up the time period for pooling and trading based on product categories.

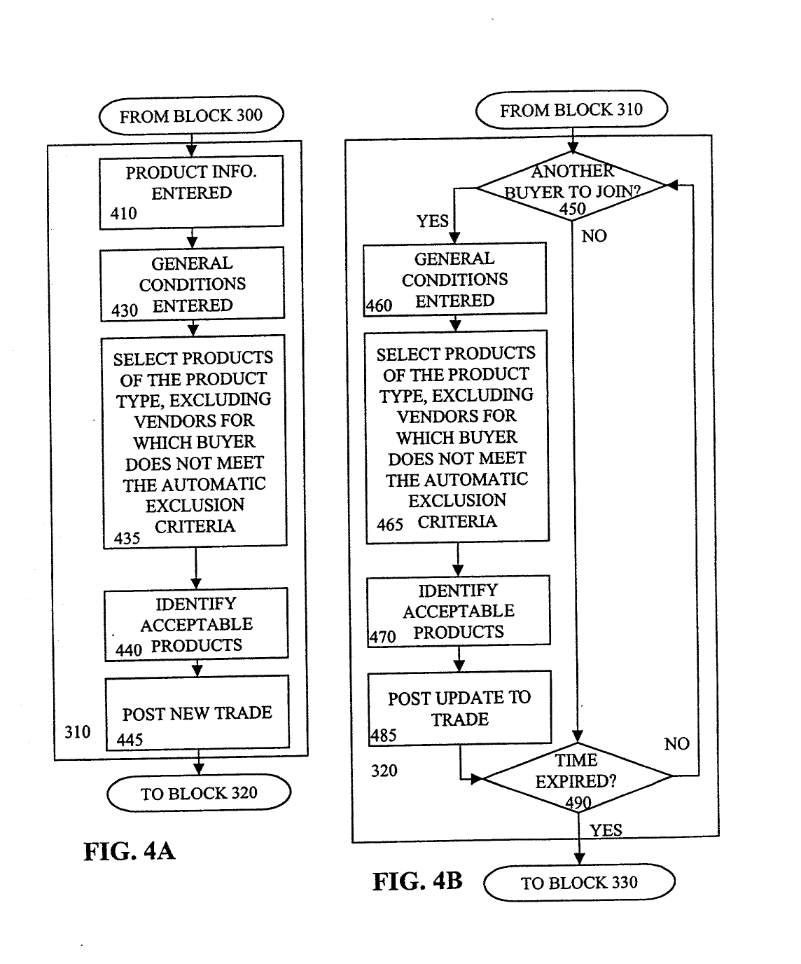

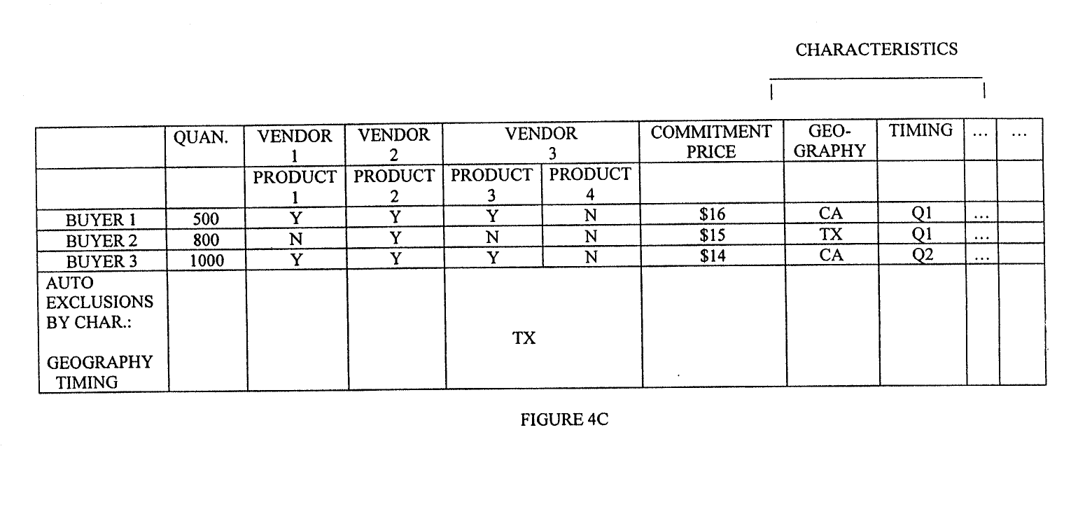

FIG. 4A is a flow diagram of one embodiment of the request for trade process (block 310) when initiated by a buyer. FIG. 4A will be described with reference to FIG. 4C. FIG. 4C is one embodiment of a table illustrating the type of information stored during the request for future trade (block 310) and buyer pooling phase (block 310) for an exemplary trade. The information show in FIG. 4C would be stored in the database(s) of the intermediary server.

In block 410 of FIG. 4A, product information is entered by a user at a buyer client 14 and transmitted to intermediary server 12. For example, a user at buyer client 14 may select a product type (or category) from a list or select a particular product from a list of products (in which case, the intermediary server identifies the product type/category) stored in products database 103. All the products in the selected product category are relatively equivalent and/or perform relatively the same function. Products may be listed by product name or by a “virtual kit list.” A list of products may be aggregated as a virtual kit list of similar products to be provided by the same vendor (i.e. different shapes of surgical instruments or accessories attached to specific capital equipment).

At process block 430, the general terms and conditions for the trade is entered by the user at buyer client 14. This information includes the quantity and a maximum price the buyer is willing to pay for the product. According to one embodiment, the maximum price corresponds to a unit acquisition price (e.g., unit, box of 50, box of 100, etc.). Alternatively, the maximum price may include an installation price and/or a service price (e.g., $50/month for 60 months for capital equipment). Also, this information may include prices for related accessories and/or disposables whose function is later described herein.

In one embodiment, the system will calculate the total maximum price per unit based on the pricing components provided. For example, assume that the disposables for different products of a given product type have different life spans/numbers of uses. In one embodiment, a given buyer may enter a projection of use (e.g., time, number of uses, etc.) and a max disposable cost for that projection. From that projection, the number of disposables required may be later calculated for each product (this later calculation allows for the normalization of different products into a single equivalent). These individualized buyer pricing components are then combined with the unit acquisition price to form the maximum price.

In other situations, buyers may not wish to and/or be unable to make such projections. In these situations, various techniques can be used, such as: 1) the max cost for a single “virtual” disposable may be entered and used; 2) a particular product's disposable (either by bundle or singles) may be selected and a max acceptable cost entered (from this information, the disposables for different products may be normalized); 3) the max cost for a single virtual disposable and the assumed life expectancy/number of uses expected may be entered (from this assumed life expectancy/number of uses, the number of disposables required may be later calculated for each product); etc.

In an alternative embodiment, certain and/or all of the pricing components beyond the unit acquisition price (e.g., the installation, service, accessories, disposables, etc.) are keep separately and/or combined into one or more sets. The information is then later used to exclude products that do not satisfy these criteria.

In addition, the general terms and conditions may include “characteristics”, for example, delivery period/timing (e.g., time start, time end, frequency of shipment), freight, a trade ID number generated by intermediary 12, and a request date (e.g., date generated by the system to allow buyers to enter their data), shipping terms (e.g., net 30 days, 60 days, 90 days, Q1, Q2, etc.), direct shipment or distributor, shipment locations, etc.

Referring to FIG. 4C, exemplary terms are conditions are shown. It is assumed in this example, that buyer 1 initiated the trade for 500 items of a product type that includes products 1-4 from vendors 1-3 at a max price of $16 per item. In FIG. 4C it is also shown that buyer 1 has characteristics of requiring shipment to CA and delivery in Q1.

In block 435 of FIG. 4A, the intermediary server 12 selects the products of the selected product type that are provided by vendors for which the buyer is not automatically excluded. In particular, vendors may have previously entered criteria which buyers must satisfy in order to be eligible to select their products. For example, in FIG. 4C vendor 3 has previously indicated that it will not ship to Texas. However, since buyer 1 has designated shipment to California, buyer 1 is not excluded from considering vendor's available products that are of the selected product type.

In block 440 of FIG. 4A, the buyer is provided a list of the selected products and identifies the ones the buyer finds acceptable for the trade. According to one embodiment, product ratings are stored in vendor database 102 by vendor and are displayed to buyers by product categories. In addition, product ratings may be organized by product number or categories. With reference to FIG. 4C, the table illustrates with “Y”s that buyer 1 identified products 1-3 as acceptable and with an “N” that product 4 is not acceptable.

At block 445 of FIG. 4A, a new trade is posted. FIG. 9B illustrates an exemplary screen snapshot received at a buyer client 14 displaying information on trades that have not yet entered the buyer pooling phase and/or on which the buyer has not entered the pool. FIG. 9D illustrates and exemplary screen snapshot received at a buyer client 14 during a request for future trade and/or during a buyer pooling phase.

In the situation where the intermediary server generates the request for future trade, the blocks in FIG. 4A differ. In particular, the blocks 430-440 need no be performed. Rather, the intermediary server selects the product type (block 410) based on some criteria (e.g., historical data, surpluses, etc.) and posts the trade (block 445).

Referring back to FIG. 3, a buyer pooling phase is commenced after the new trade is posted (block 320). FIG. 4B is a flow diagram of one embodiment of the buyer pooling phase. At process block 450, it is determined whether a buyer at another buyer client 14 wishes to join the trade. If another buyer wishes to join the trade, the buyer enters the buyer's general terms and conditions (460). In block 465, of FIG. 4A, the intermediary server 12 selects the products of the selected product type that are provided by vendors for which the buyer is not automatically excluded. Again, in FIG. 4C shows that vendor 3 has previously indicated that it will not ship to Texas. Since buyer 2 requires shipment to Texas, buyer 2 is excluded from considering vendor 3's available products that are of the selected product type. This is shown in FIG. 4C by the “N”s under vendor 3 in the row for buyer 2.

In block 470 of FIG. 4A, the buyer is provided a list of the selected products and identifies the ones the buyer finds acceptable for the trade. With reference to FIG. 4C, the table illustrates with a “Y” that buyer 2 identified product 2 as acceptable and with an “N” that product 1 is not acceptable.

At process block 480, the update to the trade is posted.

At process block 490, it is determined whether the time allotted for buyer pooling has expired. According to one embodiment, the time allotted for buyer pooling is one week. However, one of ordinary skill in the art will appreciate that other time intervals (e.g., one day, one month) may be implemented. If time has not expired, control is returned to process block 450 where it is determined whether another buyer wants to join the trade. If no buyer wants to join the trade, control is again returned to process block 460 where it is determined whether the allotted buyer pooling time has expired. Once the time has expired, the buyer pooling phase is closed. Referring again to FIG. 4C, a matrix has been formed showing with “Y”s and “N”s which products are acceptable to which buyers.

It should be noted that the products 1-4 may be the same products provided by different distributors and/or may be different products designated to be equivalent. For example, the products 1-3 may be gloves manufactured by company X and sold by vendors 1-3, while the product 4 may be gloves manufacture by company Y and sold by vendor 3. As another example, the products 1-2 may be different ventilators manufactured and sold by vendors 1-2, the product 3 may be the same ventilator as product 2 but distributed by vendor 3, and the product 4 may be a ventilator manufactured by a different company and distributed by vendor 3.

The disposable costs characteristic enables a buyer to establish a maximum price at which the buyer will pay for disposable items that operate with the product. For example, a buyer of printers may limit the prices at which the buyer will pay for printer cartridges to be used with the printer. One of ordinary skill in the art will recognize that other buyer characteristics may be included in the table and vendors may exclude trade based on those characteristics. FIG. 9C illustrates an exemplary screen snapshot received at a buyer client 14 displaying information on trades in the buyer pooling phase that the buyer has joined.

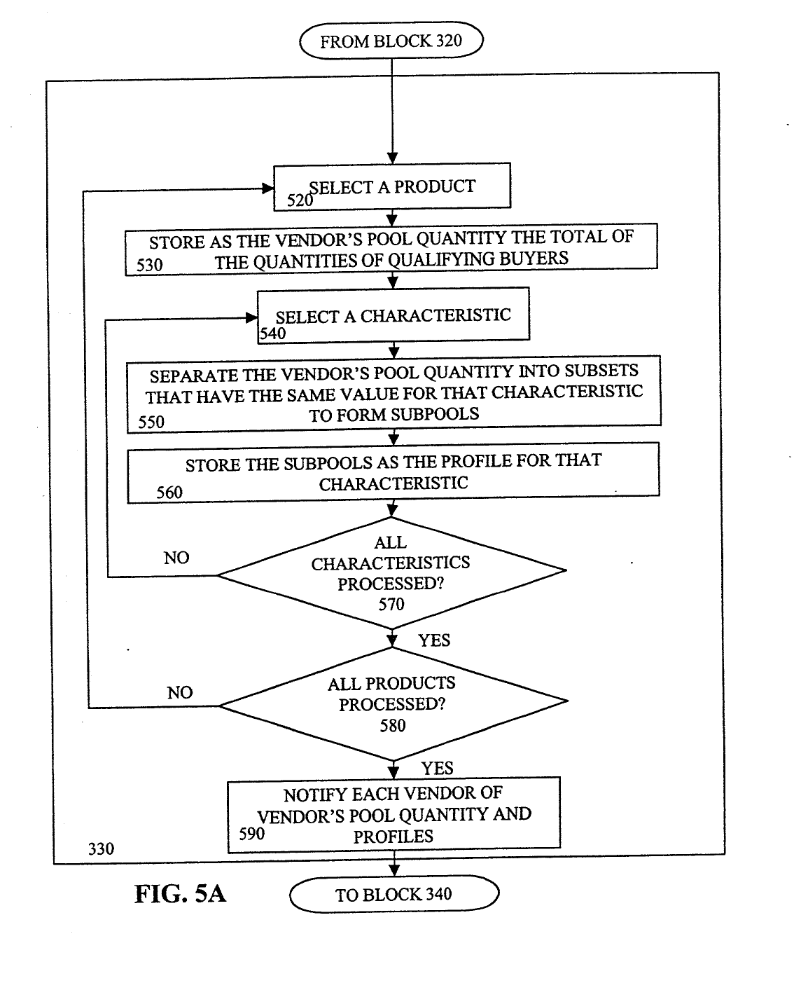

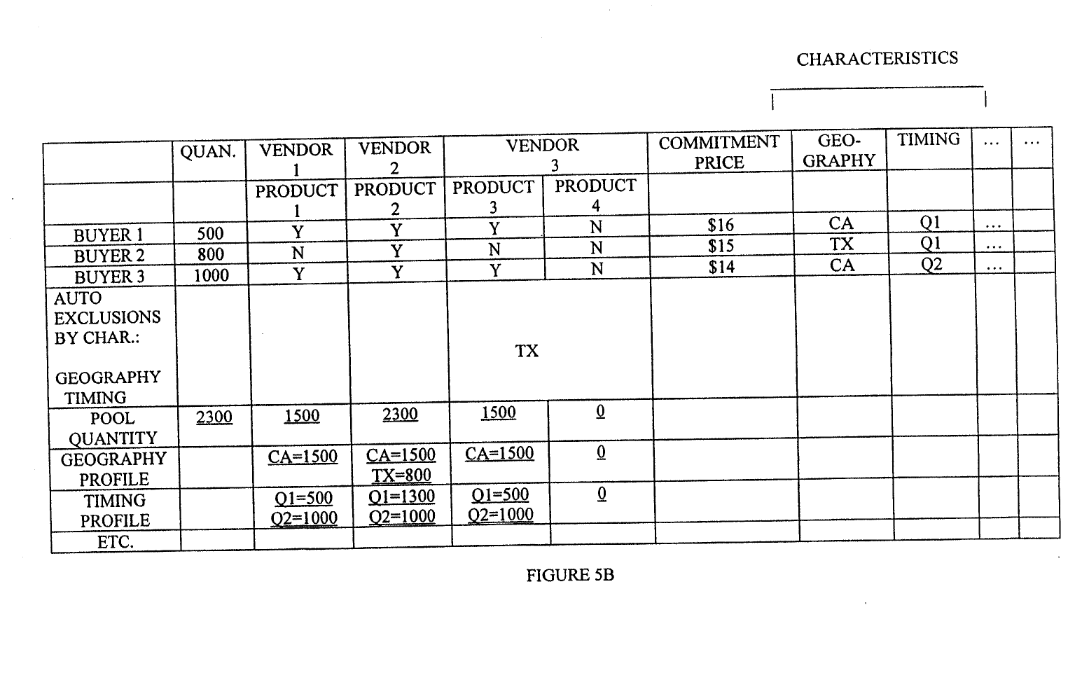

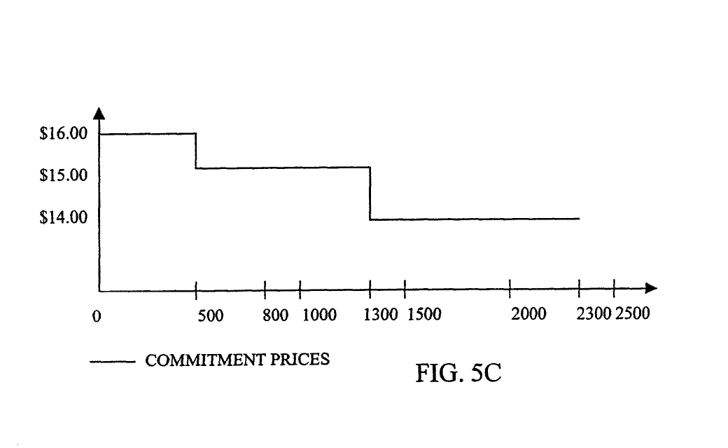

Referring back to FIG. 3, a combined request for quote is generated after the closing of the buyer pooling phase (process block 330). FIG. 5A is a flow diagram of one embodiment of the process for combining multiple request for quote (block 330). FIG. 5A will be described with reference to FIG. 5B. FIG. 5B is one embodiment of a table illustrating the type of information stored after the combined request for quote.

At process block 520, a product is selected. At process block 530, the total quantity of the selected product qualified to supply is stored as the pool quantity for that product. With reference to FIG. 5B, the column for product 1 shows that product 1 is acceptable to buyers 1 and 3. As such, from the total quantity entered for all the buyers (2300), the amount of that quantity that could be supplied with product 1 is 1500. Hence, the pool quantity for product 1 is shown in the table as 1500. It should be noted that the vendor 3 supplying products 3 and 4 has a total pool quantity of 1500 for product 3 based upon requests from buyers 1 and 2 (there is a pool quantity of 0 for product 4 because of the lack of acceptance of that product by any of the buyers).

At process block 540 of FIG. 5A, a buyer characteristic is selected. At process block 550, the vendor's pool is separated into sub-pools. According to one embodiment, the sub-pools correspond to subsets of the pool quantity that have the same value for a particular characteristic. At process block 560, the sub-pools are stored as a profile for the particular characteristic.

Referring again to FIG. 5B, the quantities are further broken down into profiles based upon various other characteristics (e.g., geographic and timing). For example, the column for product 2 shows that since buyers 1 and 3 require shipment to California and buyer 2 requires shipment to Texas, the pool quantity of 2300 is broken down in the geography profile as 1500 units for California and 800 for Texas. There is a similar break down for timing.

At process block 570, it is determined whether all of the buyer characteristics have been processed. If all of the characteristics have not been processed, control is returned to process block 540 where another characteristic is processed. Otherwise, it is determined whether all of the products have been processed (process block 580). If all of the products have not been processed, control is returned to process block 520 where another products is selected. If all of the products have been processed, each vendor is notified of their respective pool quantity and profiles (process block 590).

FIG. 5C is one embodiment of a graphical representation of a vendor trade curve. The vendor trade curve indicates the minimum prices a vendor must bid in order to gain the opportunity to supply one or more buyers. Using the table in FIG. 5B for example, a vendor must bid no higher than $16 in order to sell 500 units, $15 to sell 1300 units and $14 to sell 2300 units.

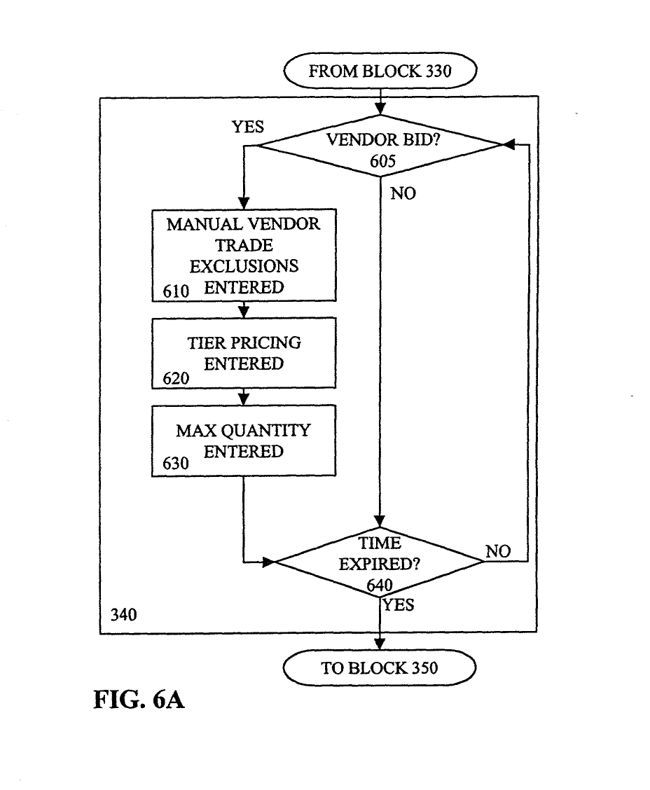

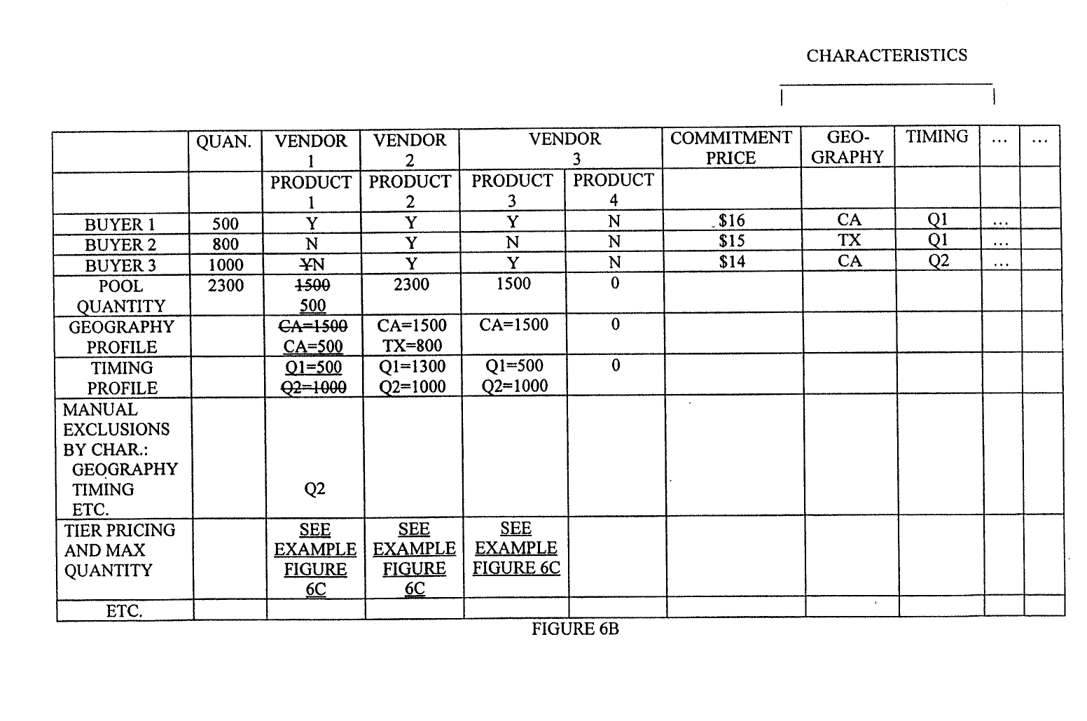

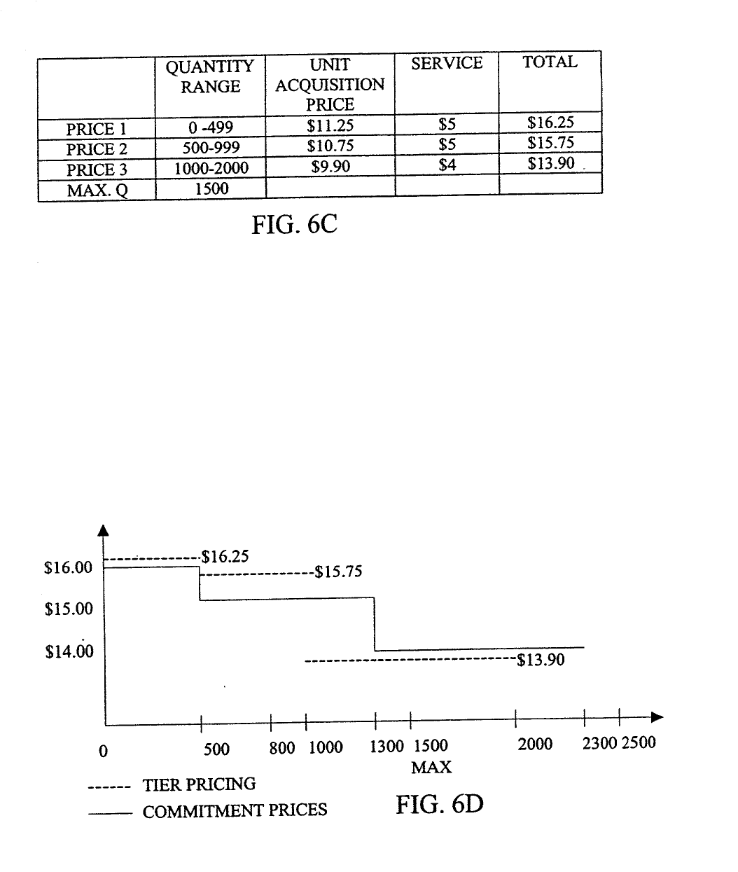

Referring back to FIG. 3, a vendor pooling phase is commenced after generating the combined request for quote (process block 340). FIG. 6A is a flow diagram of one embodiment of the vendor pooling process. At process block 605, it is determined whether any vendor wishing to submit a bid. If so, control passes to block 610. Otherwise, control passes to block 640.

At process block 610, one or more manual trade exclusions may be entered by a vendor at a vendor client 16. A manual trade exclusion operates the same as an automatic trade exclusion, with the exception that automatic trade exclusion are for somewhat permanent preferences of a vendor that were previously stored.

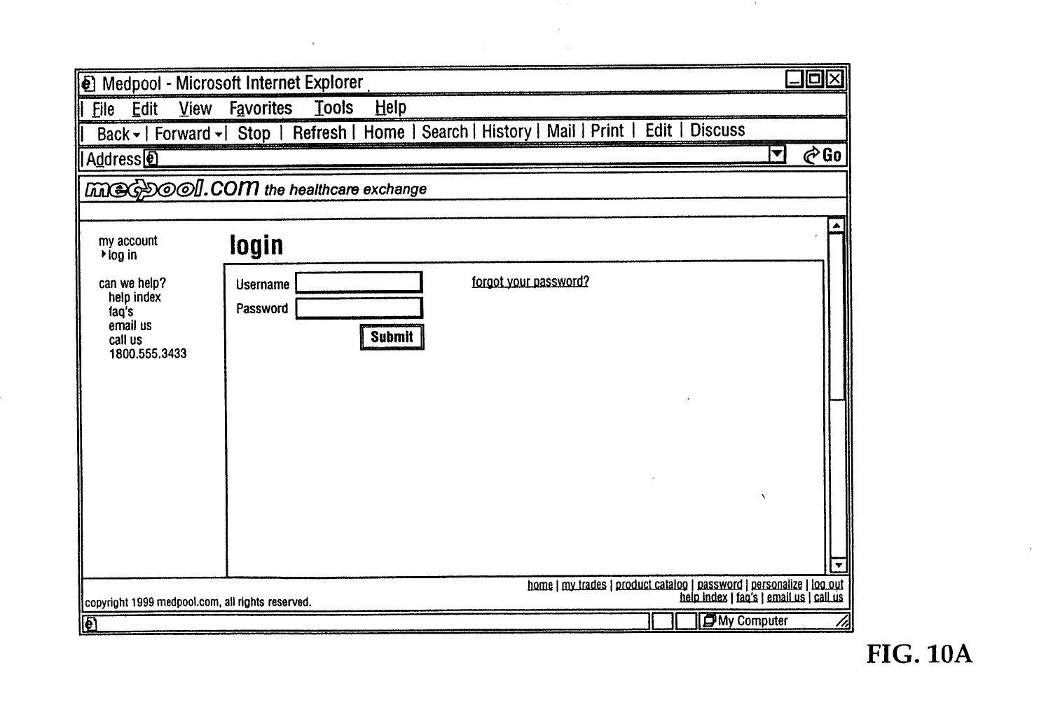

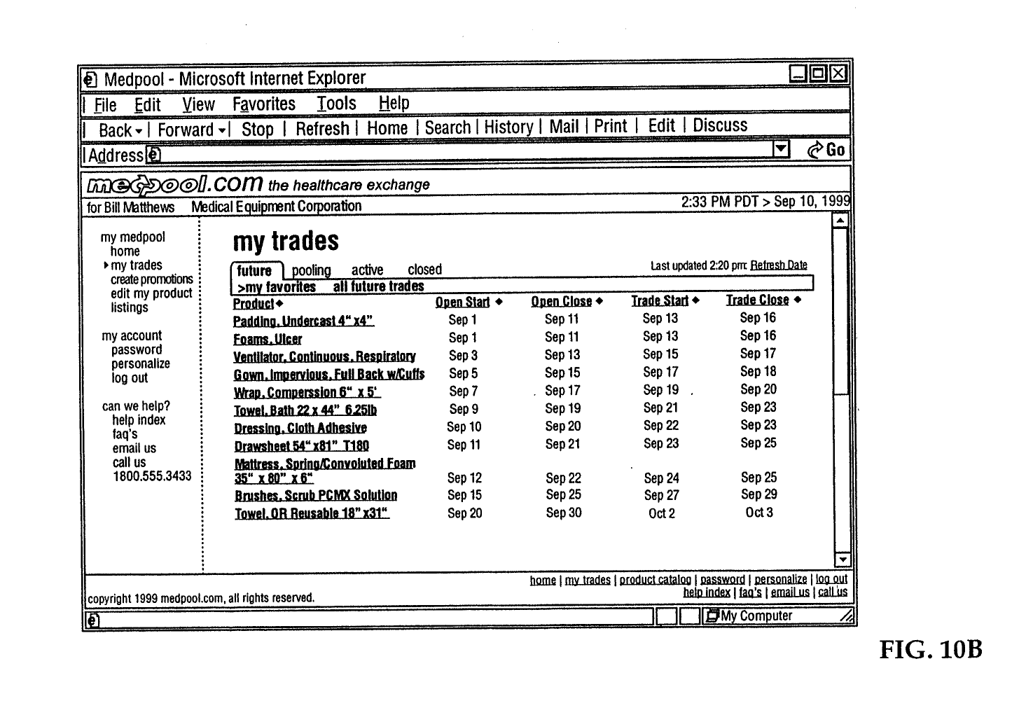

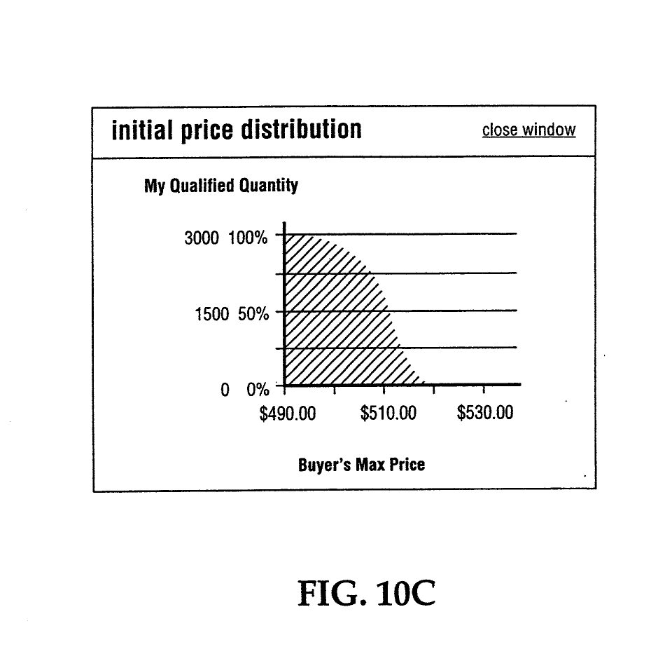

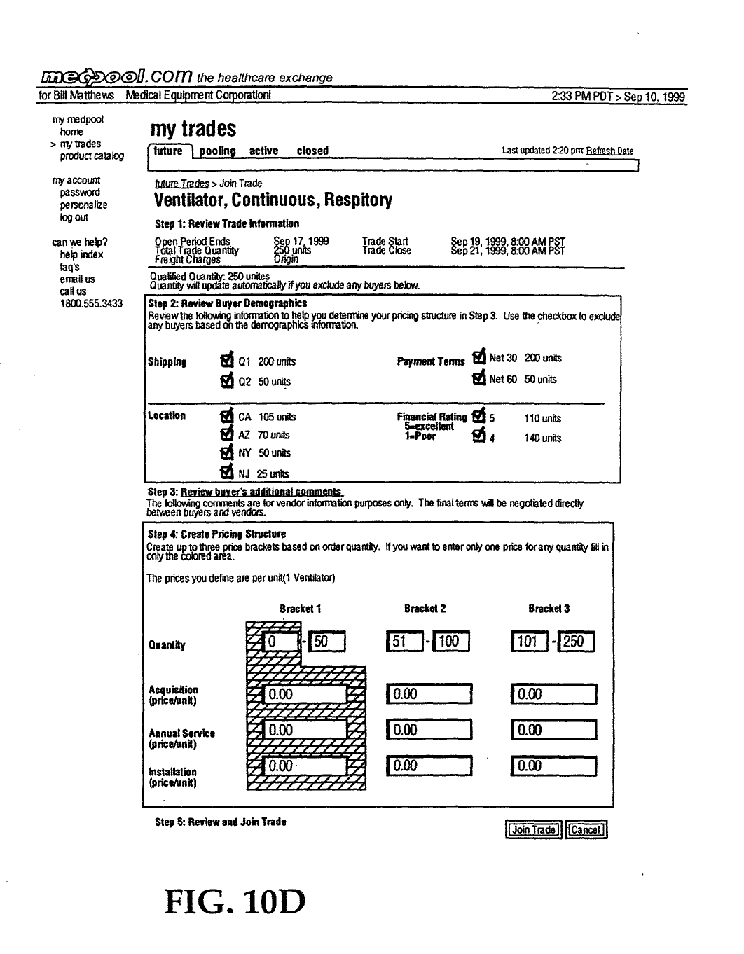

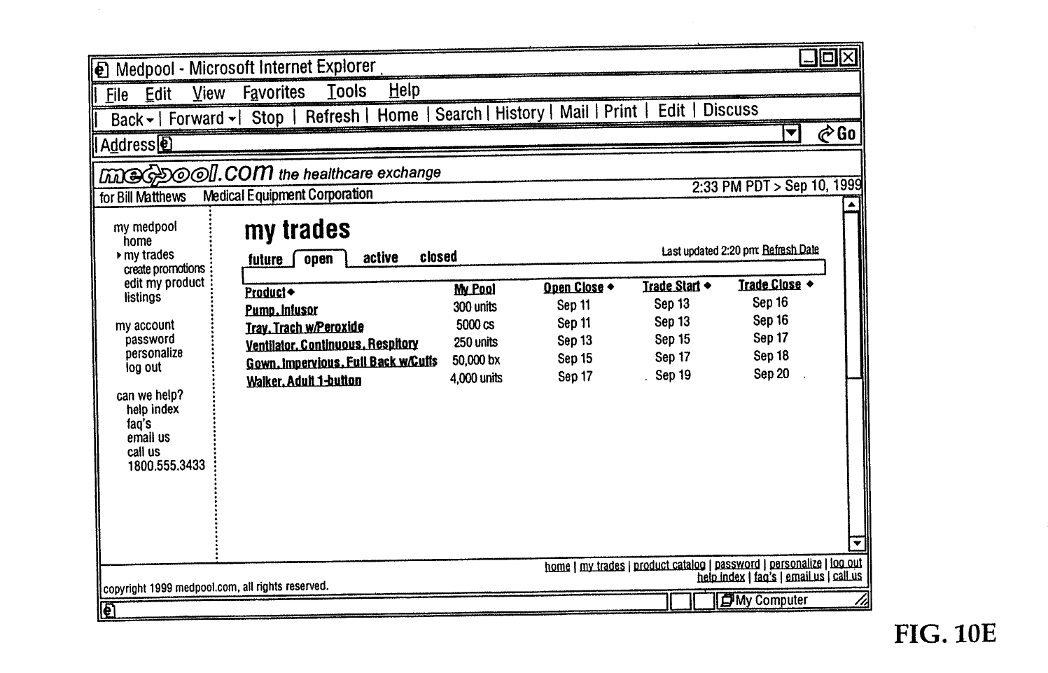

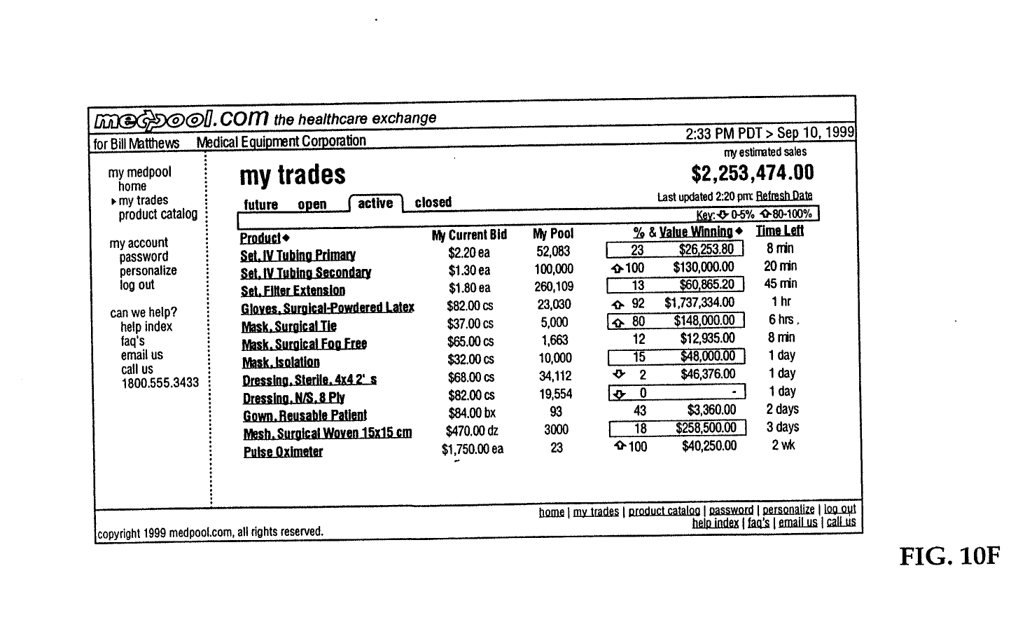

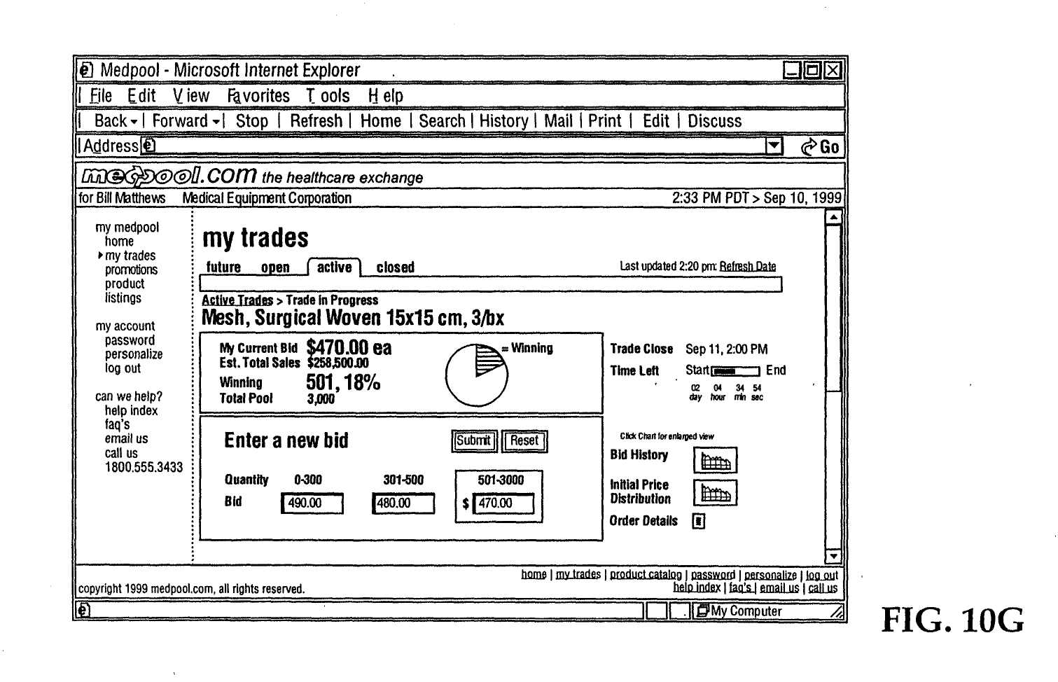

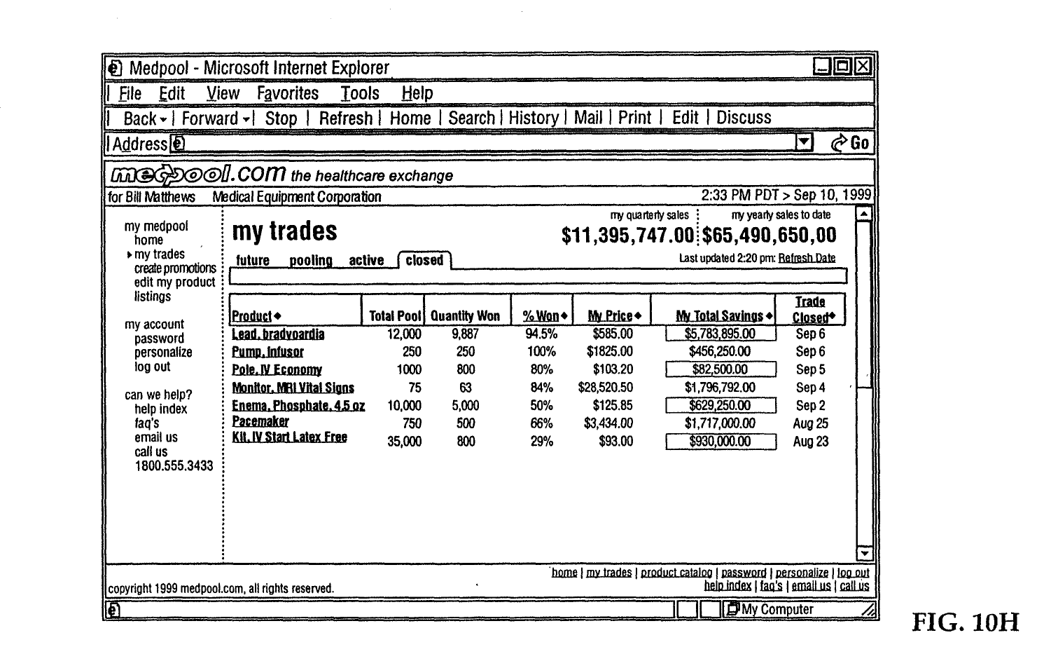

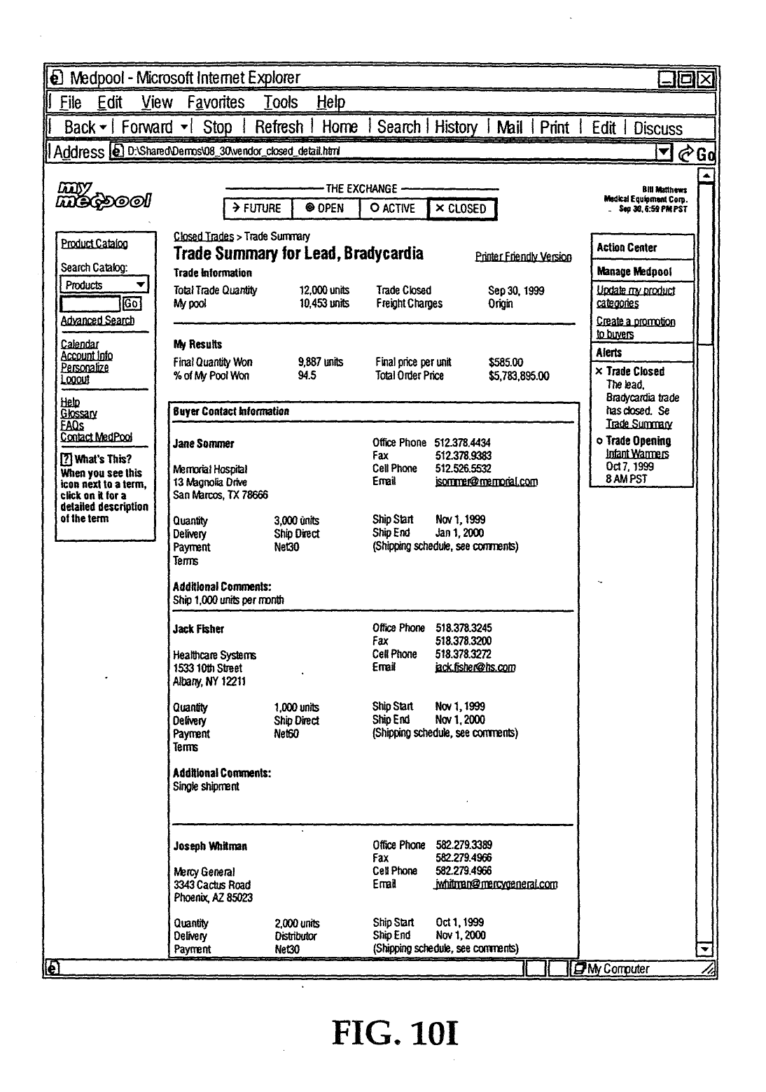

At process block 620, tier pricing may be entered by a vendor. At process block 630, a maximum quantity is entered. FIG. 10D is an exemplary screen snapshot received by a vendor client during the initial bid of the vendor. FIG. 10E is a screen snapshot received at a vendor client displaying information on trades in the vendor pooling phase that the vendor has joined.

FIG. 6B is one embodiment of a table illustrating the type of information stored after the vendor pooling phase. The table is updated to reflect manual exclusions entered by vendors selling the products. For example, vendor 1 excludes orders in Q2, and thereby excludes buyer 3 as a possible buyer of product 1 based upon the timing of the order. As a result, vendor 1's pool quantity and profiles are recalculated to reflect the exclusion. It should be noted that the automatic and manual exclusions are not buyer specific. Rather, in one embodiment, the vendors are not informed of which buyers are involved in the combined request for quote (the buyer's anonymity is preserved). As such, the automatic and manual trade exclusions are based upon the characteristics of the buyers. The table also includes an entry for the tier pricing of each product vendor.

FIG. 6C illustrates one embodiment of tier pricing entered by a vendor. A vendor may enter an initial bid for each tier quantity pricing range determined by the vendor in which the vendor has a product that is acceptable. In addition, the vendor may enter a maximum quantity of the product which the vendor can supply. In certain embodiments, a vendor may also enter other price component information (similar to that discussed above—e.g., a service price, installation price, related accessories prices, disposables price, etc.) in addition to a price for each unit to be sold. As described, above, in certain embodiments the system will calculate the total bid price per unit based on the provided price components by each vendor. Furthermore, as described above, this may involve the normalization of components, such as disposables. Of course, in embodiments in which this information is kept separately or in sets (as described above), separate calculations would be performed as necessary.

FIG. 6D is one embodiment of a graphical representation of a vendor trade curve combined with tier pricing. Note that the vendor's pricing tiers are only acceptable for the 1000-2000 range since the prices for the other tiers are higher than the maximum commitment prices. FIG. 10B illustrates an exemplary screen snapshot received at a vendor client 16 illustrating trades that have not yet entered the vendor pooling phase and/or that the vendor has not entered a bid on. FIG. 10C illustrates an exemplary screen snapshot which may be received at a vendor client 16 displaying information regarding a vendor's subpool.

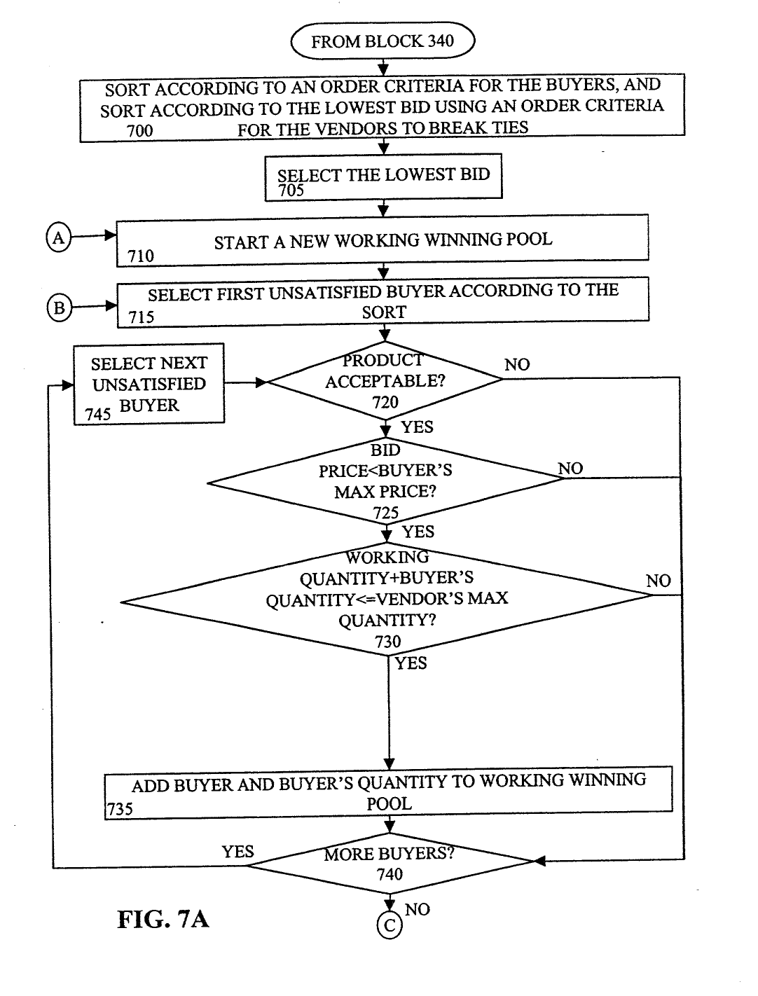

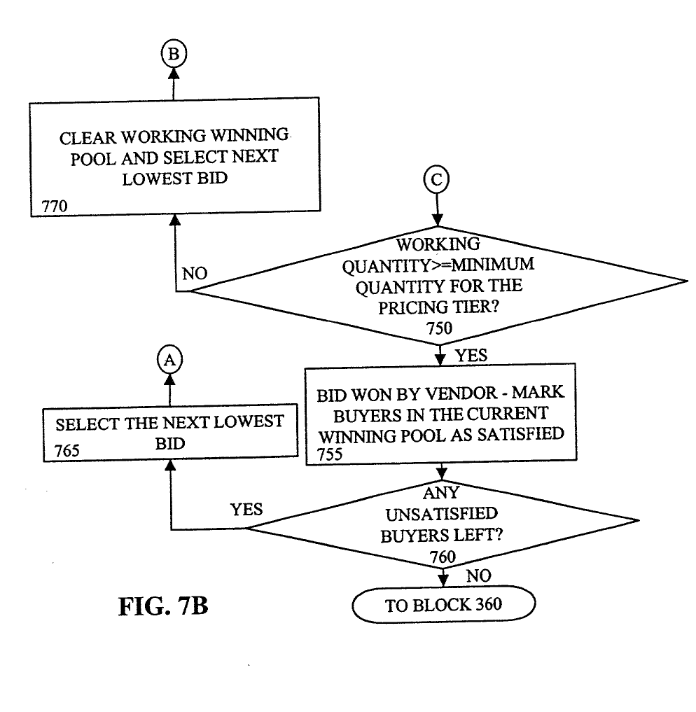

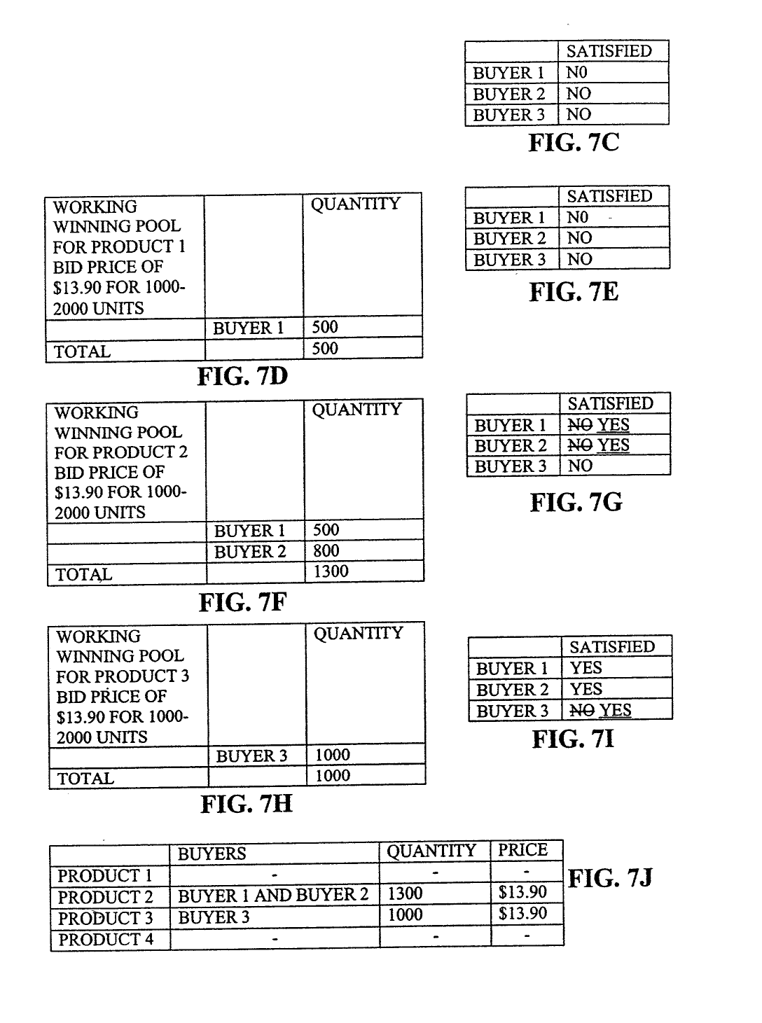

Referring back to FIG. 3, a current bidding state is generated after the vendor pooling phase (process block 350). FIG. 7A and 7B illustrate a flow diagram of one embodiment of bidding state generations.

Referring to FIG. 7A, a sort according to a predetermined order criteria of buyer entries is implemented at process block 700. In addition, a sort according to the lowest product bid is carried out, with a vendor order criteria used to break ties. The criteria for the buyer and vendor can take a number of different forms. For example, the criteria for the buyers and or vendors may be the order of entry into the pool, the order of largest to smallest quantity, the order of smallest to largest quantity, an order based on number and/or volume of past trading, etc.

At process block 705, the lowest bid based upon the sort is selected. At process block 710, a new working winning pool is started. At this point, a working winning pool represents a scratch area for calculating a pool of buyers for which a given bid qualifies. As described later herein, a working winning group may succeed or fail. Working winning groups that fail are dumped, whereas those that succeed represent the current bidding state.

At process block 715, a first unsatisfied buyer is selected. An unsatisfied buyer is one that has not already been matched with a particular product to supply the buyer's request.

At process block 720, it is determined whether the product corresponding with the lowest bid is acceptable for the selected unsatisfied buyer. If the product is not acceptable, it is determined whether there are more unsatisfied buyers to process at process block 740.

If the product is acceptable, it is determined whether the selected bid price is less than the buyer's maximum commitment price (process block 725). According to one embodiment, it may also be determined whether the price for disposable items to be sold with the product is below or equal to what the buyer is willing to pay. If the bid price is greater than the buyer's maximum price, control again passes to process block 740. However, if the bid price is less than the buyer's maximum price, it is determined whether the sum of the working quantity and buyer's quantity is less than or equal to the vendor's maximum quantity illustrated in FIG. 6C process block 730). The working quantity is the running total amount of units of a given winning working group. Thus, when a new winning working group is started, the working quantity is zero.

If the combination of the working quantity and buyer's quantity is greater than the vendor's maximum quantity, control again passes to process block 740. If the combination of the working quantity and buyer's quantity is less than or equal to the vendor's maximum quantity, the buyer and the buyer's quantity is added to the working winning pool (process block 735).

At process block 740, it is determined whether there are more unsatisfied buyers that have not been considered for the currently selected bid. If there are more buyers, the next unsatisfied buyer is selected at process block 745 and control is returned to process block 720.

Referring to FIG. 7B, if there are no more unsatisfied buyers that have not been considered for the currently selected bid, it is determined whether the working quantity is greater than or equal to the minimum quantity for the pricing tier at process block 750. If the working quantity is less the minimum pricing for the pricing tier, the working winning pool is cleared and the next lowest bid is selected at process block 770. As a result, control is returned to process block 715 where a first unsatisfied buyer according to the sort is again selected. Although it is not illustrated in FIG. 7B, if there is not another bid to be selected from in block 770, the current working winning pool would be deleted and control would pass to block 360.

If it was determined in block 750 that the working quantity is greater than or equal to the minimum pricing for the pricing tier, the product bid is won by the vendor (process block 755). Once a bid is won by a vendor, buyers in the current winning pool are marked as satisfied and the current working winning pool becomes part of the current bidding state. From block 755, control passes to block 760.

At process block 760, it is determined whether there are any unsatisfied buyers remaining. If there are no more unsatisfied buyers remaining, the current bidding state is completed and control passes to block 360. Otherwise, the next lowest bid is selected at process block 765 and control is passed back to block 710. Although it is not illustrated in FIG. 7B, if there is not another bid to be selected from in block 765, control would instead pass to block 360.

FIGS. 7C-J illustrate an example of bidding state generation with respect to the values included in the table of FIG. 6B and maximum quantities and bid pricing tiers in FIG. 6C. To show certain features of the invention, this example assumes that the bids for each product are the same. However, it is understood that this need not and will not likely be the case. In addition, it is assumed in this example that the buyers 1-3 orders were received in respective order, and the vendor 1-3 bids were received in respective order.

FIG. 7C illustrates the satisfaction status of the buyers at the beginning of the bidding state. Thus, FIG. 7C illustrates that none of the buyers have yet been satisfied.

To being, the lowest bid is selected in block 705. The lowest bid is $13.90 in the third price tier. Since all of the vendors 1-3 bid the same amounts for the same pricing tiers, the vendor order criteria is used to break the tie. In this example, the vendor order criteria is the order of entry into the pool. Since in this example vendor 1 was the first to submit a bid, the bid based on product one is the first bid selected. Notice that there are no bids for product 4 due to unacceptability and exclusions.

Next, a winning pool is started. Subsequently, the first unsatisfied buyer is selected. In this example, the buyer order criteria is the order of entry into the pool; thus, buyer 1 is selected (block 715). Since product 1 is acceptable to buyer 1, the product 1 bid price is compared to Buyer 1's maximum commitment price ($16) (block 725). Since the bid price is less than the maximum price, and the working quantity (0) plus buyer 1's (500) quantity is less than the maximum quantity for product 1 (1500 from FIG. 6C), buyer 1 and the quantity of 500 is added to the working winning pool (block 735). FIG. 7D illustrates a current status of the working winning pool.

Next, buyer 2 is selected as the next unsatisfied buyer (blocks 740 and 745). However, since the table indicates that product 1 is not acceptable to buyer 2 (block 720), another buyer is to be selected (block 745). Similarly, buyer 3 has been excluded by the vendor 1; thus another buyer is to be selected. Since there are no more buyers to be selected, the working quantity in the working winning pool (500) for product 1 is compared to the minimum quantity for pricing tier in FIG. 6C (1000) (block 750). Since the working quantity for the vendor 1 in the working winning pool (500) is less than the minimum quantity for pricing tier 3 (1000), the working winning pool is cleared and the next lowest bid is selected (block 770). FIG. 7E illustrates the satisfaction status of the buyers after the product 1 bid of $13.90 has been processed.

The $13.90 bid of product 2 in bid pricing tier 3 is next selected as the lowest bid, a new working pool is started, and buyer 1 is selected (block 705-715). The process described in blocks 725-740 above with respect to product 1 for buyer 1 is repeated for product 2. However, product 2 is also acceptable to buyer 2 (block 720). Since the bid price ($13.90) is less than buyer 2's maximum price ($15) and working quantity (500 form buyer 1)+buyer 2's quantity (800) is less than the maximum quantity (1500) for the vendor 2, buyer 2 and the buyer 2's quantity is added to the working winning pool (blocks 725-735). FIG. 7F illustrates the current status of the working winning pool after buyer 2 is added for product 2.

Since product 2 is also acceptable to buyer 3 and the bid price is less than buyer 3's maximum price ($14), the process in blocks 720 and 725 is repeated for buyer 3. However, since the working quantity for the current working winning pool (1300 form buyers 1 and 2)+buyer 3's quantity (1000) is greater than the maximum quantity (1500) for vendor 2, buyer 3 cannot be added to the working winning pool (block 730). Further, since there are no more buyers to be selected, and the working quantity for product 2 (1300) is greater than the minimum quantity for pricing tier 3 (1000), vendor 2 wins the bid and buyers 1 and 2 are marked as satisfied (blocks 740-750). FIG. 7G illustrates the satisfaction status of the buyers after the $13.90 product 2 bid has been processed.

Since buyer 3 is still unsatisfied, blocks 710-755 are repeated with the next lowest bid, which is the $13.90 bid of product 3 for the third pricing tier. The process ends with buyer 3 being satisfied. FIG. 7H illustrates the current status of the working winning pool after buyer 3 is added for product 3. FIG. 7I illustrates the satisfaction status of the buyers after the $13.90 product 3 bid has been processed. Note that all buyers have been satisfied. FIG. 7J illustrates the current bidding state.

One of ordinary skill in the art will appreciate that the above example is only one scenario of the current bid state generation. For example, FIGS. 7A and B show a method by which the working winning groups are filled according to the ordering based on the buyer criteria is shown. Alternative embodiments could use other techniques (e.g., a best fit algorithm—the buyers to fill a given bid would be selected to have the maximum quantity).

Referring back to FIG. 3, the current bidding state is distributed to the buyers and vendors after the current bidding state generation (process block 360). As can be seen from the above, the pool quantity does not have to be, and at times is expected not to be, satisfiable by one product/vendor. Rather, the pool quantity is broken down by product into potentially overlapping subpools based on the individual selection of acceptable products by the buyers. The subpool for a given vendor's product(s) will appear during the real time bidding as a single “virtual buyer.” It should also be noted that these individual subpools for the different products are interrelated based upon the buyer/product matrix (see the example shown in FIG. 6B).

The first pass through process blocks 350 and 360 may be referred to as generating an initial bidding state (365). At process block 370, it is determined whether a new bid is received from a vendor before an allotted time for bidding has expired. If a new bid is received, control is returned to process block 350 where another bidding state is generated. In addition to or in lieu of generating new bid states responsive to each bid, alternative embodiments can be implemented to generate new bid states responsive to other criteria (e.g., in one embodiment, new bids are collected during regular time intervals after which a new bidding state is generated and posted to participating vendors and buyers).

If no new bid has been received, it is determined whether the allotted time has expired (process block 380). According to one embodiment, one week is allotted for bidding by vendors. However, other periods of time (e.g., one day, one month, etc.) may be allotted for the bidding. If the time has not expired, control is returned to process block 370 where it is determined whether a new bid has been received. If the allotted time has expired, the trade is closed at process block 390. Successive passes from process blocks 350 through 380 may be referred to as the real time bidding phase. FIGS. 9E and 9F illustrate exemplary screen snapshots received at a buyer client 14 displaying information during an active real time bidding phase. FIGS. 10F and 10G illustrate exemplary screen snapshots received at a vendor client 16 displaying trades in an active real time bidding phase. In particular, FIG. 10G illustrates to the vendor how much of its subpool it is currently winning based on its current bids (i.e., since the subpools can overlap, the bids of vendors are interrelated; as such, bid changes by other vendors during the real time bidding can effect part of all of other vendors subpools based on the buyer/vendor matrix). In this manner, real time feedback is provided to the vendor's regarding their status.

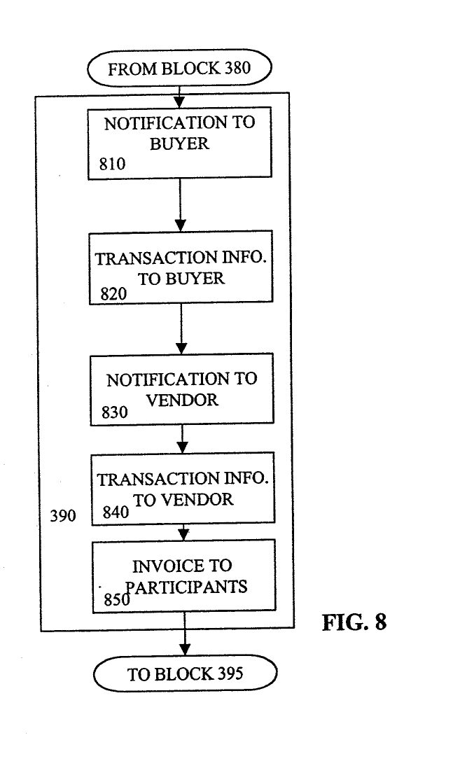

FIG. 8 is a flow diagram of the close trade phase at process block 390. At process block 810, notification is transmitted from intermediary server 12 to each buyer at buyer clients 14. At process block 820, transaction information is transmitted to the buyers. At process block 830, notification is transmitted from intermediary server 12 to each vendor at vendor clients 16. At process block 840, transaction information is transmitted to the vendors. At process block 850, a sales invoice is transmitted to each vendor and/or buyer. In one embodiment, a sales invoice is charged only to the specific vendors who won a trade pool after the close trade phase. FIGS. 9G and 9H illustrate exemplary screen snapshots received at a buyer client 14 displaying information during a closing phase. In particular, FIG. 9H reveals the identity of the anonymous winning vendors. It should be noted that this is the first time a buyer knows what of his selected vendors was winning the bid, and the buyer only learns the identify of the vendor that won their bid (whether other vendors won bids and/or bid at all remains anonymous). Furthermore, a given buyer never learns the identity of any of the other participating buyers.

FIG. 10H illustrates an exemplary screen snapshot received at a vendor client 16 displaying information during a closing phase. FIG. 10I illustrates an exemplary screen snapshots received at a vendor client displaying information about a specific trade; in particular, the identity of the anonymous winning buyers is provided. It should be noted that this is the first time a vendor knows who any of the buyers were, and the vendor only learns the identify of the buyers they have won (the buyers that the vendor did not win remain anonymous).

By pooling orders, maintaining buyer's preferences, communicating volume/pricing tradeoffs to vendors, the current invention creates the opportunity to optimize the price obtained by the entire pool of buyers in the aggregate. In addition, more purchasing power is provided to buyers and more lower-cost and larger volume sales to the vendors.

It should be understood that several inventions have been described above. Each of these inventions has been used independently of the other. For example, one invention is the concept of pooling the buyers according to a buyer/vendor matrix. Once the buyers are pooled, the system could be designed to handle the matching of bids to buyers any number of different ways (e.g., one such system could require that only vendors that can satisfy their entire subpools can participate; one such system could require that only vendors that can satisfy the entire pool can participate; rather than supporting real time bidding, another such system could allow for each vendor to submit only a fixed number of bids (e.g., only one); another such system could provide the combined request for quote to only one vendor; etc.).

Another invention is the concept of normalizing products in the buyer pooling environment. For example, this can occur: as a result of the way the products are stored by product type in the database, the way the buyers can select which products they are willing to accept, the way the other pricing components are normalized, etc.

Yet another invention is the concept of having the combined request for quote broken down into subpools by product, where the subpools for different products may or may not overlap different buyers and where the subpools are bid on by the corresponding vendors. Alternative embodiments may require that only the products that are acceptable to all of the buyers be allowed to be in the combined request for proposal.

Regardless of how the request for quote is generated, another invention is the manner of handling vendor pooling. For example, one invention is the concept of having subpools for different products and providing real time bidding on the vendor's on their respective subpools. In addition, an aspect of the invention is the concept of providing to the vendor's real time information regarding their status with respect to their subpool (e.g., how much of their subpool(s) they are capturing at their current bid(s)). Again alternative embodiments, could allow for a fixed number of bids (e.g., two). As another example, a system can provide that only a single buyer submits a request for quote and the vendor pooling is performed. In such a system, the subpools could be formed based on various criteria (e.g., the characteristics—if the single buyer needs products shipped to different locations, different timing, etc.). While different degrees of anonymity have been described, it is understood that other degrees of anonymity could be used.

Yet another invention is a method and apparatus for implementing preferential selection of offers. While a pooling system for matching buyer(s) and seller(s) has been described, many methods of matching buyer(s) and seller(s) are known (see e.g. Background of the Invention). The use of preferential selection of offers may be used in any such system.

Most of the matching techniques have a method of entering prices or other criteria. For example, in reverse auction systems it is not uncommon to have a buyer indicate a desired product and a maximum price the buyer will pay for the desired product. Likewise, many methods exist for receiving bids or offers to purchase or sell a product. In particular, bids may be made after a request for bids is received or otherwise entered or communicated. Standing bids may be entered prior to or subsequent to receiving requests for bids, and those bids may be used either for a limited time, until a limited quantity of products are matched to the bid, or in an unlimited manner.

In many instances, a buyer may be seeking a low price for any product in a transaction, but be willing to pay a slightly higher price for a preferred result of a transaction, such as the purchase of one preferred product in preference to another (such products may be sold by the same vendor or different vendors), or the purchase of a product from one vendor in preference to another, the purchase of a product with a preferred feature (e.g. a direct flight over a non-direct flight for an airline ticket), etc. Implementing such a preferential selection of offers to purchase or sell may be done in the following manner.

### UNMET DEMAND

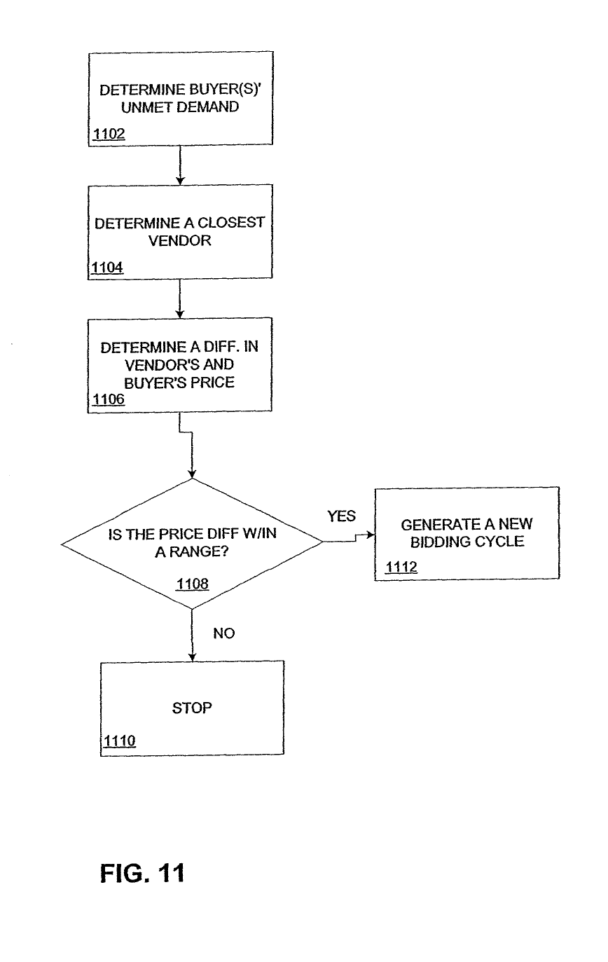

With attention to FIG. 11, a more detailed explanation of one embodiment of the invention may be presented. In particular, FIG. 11 is a flow diagram of one embodiment of meeting the unmet demand of buyers for a quantity of business that was not satisfied in the prior bidding cycles in an on-line bidding transaction. The embodiments of the flow diagram of FIG. 11 are described in relationship to the bidding process illustrated in FIG. 3. However, embodiments of the present invention are not so limited, as the flow diagram illustrated in FIG. 11 is applicable to any other type of bidding process, as will be illustrated below.

Returning to FIG. 3, after the trade has closed at process block 390 and prior to stopping the process at process block 395, additionally processing to meet unmet demand is performed, as illustrated by the flow diagram in FIG. 11. FIG. 11 is described and illustrated in terms of one buyer. However, this process is repeated for each buyer involved in the open market sales transaction described in FIG. 3, who still has a demand for a quantity of business that is unmet by the prior bidding cycles described in conjunction with FIG. 3.

At process block 1102, intermediary server 12 determines what quantity of business that a given buyer client demands is still unmet despite the prior bidding cycles. A given buyer client is committed to a quantity of business designated by the buyer client if a certain price has been met by vendors also designated by the buyer client. However, due to a difference in the price that the buyer client is willing to pay and the price that the vendors are willing to sell, this demand by the buyer client is unmet. At process block 1104, for each buyer client having unmet demand from the prior bidding cycles, intermediary server 12 determines which of the designated vendors is closest (hereinafter “the closest vendor”), in terms of price, to the buyer client for each quantity of business that is unmet. Accordingly, this phase illustrated in FIG. 11 is different from the prior bidding phase as only one vendor is allowed to compete for this unmet demand of a given buyer.

In order to determine the closest vendor, a value needs to be assigned to each of the different vendors for the different quantities of business. In one embodiment, this value for a given vendor is the value of the transacted amounts in the prior bidding cycles to which the given vendor is committed. In an embodiment, a given vendor's price is assigned a value equaling one of their prior bids when the given vendor does not have any transacted amounts from prior bidding cycles.

In another embodiment of a multi-tiered bidding system, the potential business in this new bidding cycle from vendors having unmet demand is taken into account in determining a given vendor's bidding price. In particular, if a given vendor's price would be lowered by going into a new tier due to the additional potential quantity of business, such price is used as the vendor's price. In one such embodiment, the given vendor is given an opportunity to enter another tier in their multi-tier bid, thereby lowering their price, based on the potential of receiving additional business. The embodiments for determining a price for a given vendor are by way of example and not by way of limitation as other techniques may be employed to arrive at a price for the different vendors. Accordingly, different embodiments can be employed in determining a value to be assigned to each of the different vendors for the different quantities of business.

At process block 1106, for each buyer client, intermediary server 12 determines a difference between the price that the buyer client is willing to pay and the price that the closest vendor is willing to sell for a given quantity of business. At process decision block 1108, for each buyer client, intermediary server 12 determines whether this difference is price is within a range. In other words, intermediary server 12 determines whether the two different prices proffered by the buyer and the closest vendor are within such pre-agreed range of one another. In one embodiment, the range is based on a price amount. For example, the range value could be $1 per quantity of business. Accordingly, if the closest vendor price is $100 per quantity of business, any amount proffered by the buyer that is less than $99 per quantity of business is not within range, while any amount greater than or equal to $99 per quantity of business is within range.

In another embodiment, the range is based on a percentage. In particular, the range is based on a percentage of closeness that the two proffered prices are within one another. For example, the range percentage could be 5%. Accordingly, if the closest vendor price is $100 per quantity of business, any amount proffered by the buyer that is less than $95 per quantity of business is not within range while any amount greater than or equal to $95 is within range. However, embodiments of the present invention are not limited to a price amount or percentage of closeness in determining a range, as any other criteria can be incorporated into embodiments of the invention in determining the range or striking distance.

At process decision block 1108, if the price difference is not within the given range, the process is complete for that buyer at process block 1110, returning to stop block 395 in FIG. 3, as the price difference is considered to be out of range to justify another bidding cycle. However, if the price difference is within the given range, a new bidding cycle is generated at process block 1112 for that buyer.

Moreover, the range or striking distance can be set or determined at various times during the bidding cycles. In an embodiment, the range is set prior to any bidding activity as this value is predetermined prior to entering process block 310 of FIG. 3. In another embodiment, the range is not determined until the decision is made to generate a new bidding cycle at process block 1112. However, embodiments of the invention are not so limited, as this range could be set at other stages in the bidding process. For example, in one embodiment, the range could be set prior during the prebid vendor pooling phase at process block 340.

Additionally, the range or striking distance can be set or determined by various entities. In an embodiment, the range is set by the vendor(s). In alternative embodiment, the range is set by the buyer(s). In one embodiment, this range is determined by intermediary server 12. In other embodiments of the invention, this range could be set by a combination of entities listed in the above embodiments. For example, in one such embodiment, the range is an average of a range desired by the vendor(s) and a range desired by the buyer(s). Further, in other embodiments of the invention, this range can be set by various other criteria and/or entities. In one such embodiment, this range could be set based on the propensity of the vendor and/or buyer to be within a certain range and/or the propensity of the vendor and/or buyer to compromise in this additional bidding cycle at process block 1112, which is further described below. For example, intermediary server 12 could track the history of the vendor(s) and/or buyer(s) during prior bidding cycles to determine the propensity of such entities to be within the range and/or to compromise when such entities are within the range.

Further, the range or striking distance can be set by various entities, as previously described, in different combinations with the timing of the setting, as previously described. For example, in one embodiment, the range is set prior to any bidding phases by the vendor(s). In another example, intermediary server 12 determines the range at the time the new bidding cycle is generated. These examples of different combinations are by way of illustration and not by way of limitation, as there can be any combination of which a particular entity sets the range in conjunction with when the range is set.

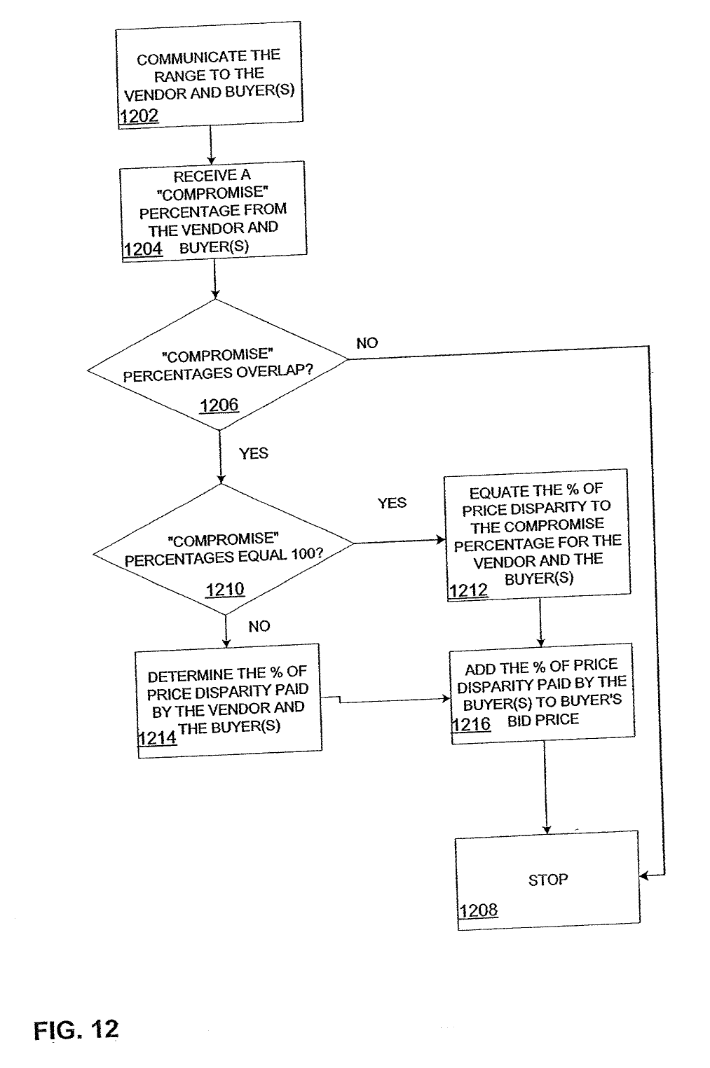

FIG. 12 is a flowchart diagram of one embodiment of the new bidding cycle generated at process block 1112. At process block 1202, intermediary server 12 communicates the range to the vendor and the set of one or more buyers. The vendor and/or the set of one or more buyers are then allowed to compromise to resolve a small disparity in the price of a quantity of business.

At process block 1204, intermediary server 12 receives back a “compromise” percentage from both the vendor and the set of one or more buyers. A “compromise” percentage is defined as a percentage of the price disparity that a given entity (i.e., the vendor or the buyer) is willing to forego in order to consummate the sales transaction. For example, if the price disparity is $5 per quantity of business and the vendor transmits a “compromise” percentage of 50% to intermediary server 12, the vendor is willing to forego $2.50 per quantity of business in order to consummate the sales transaction.

Accordingly, the vendor and the buyer can enter a “compromise” percentage from zero to one hundred. In one embodiment, the vendor and the buyer can enter a “compromise” percentage of (1) 100%, (2) 50% or (3) 0%. If a given entity enters 100% for the “compromise” percentage, this entity is willing to forego the entire price disparity in order to consummate the sales transaction. In other words, this entity is willing to absorb the price disparity to consummate the sales transaction. If a given entity enters 50% for the “compromise” percentage, this entity is willing to forego one half of the price disparity. Further, if a given entity enters 0% for the “compromise” percentage, this entity is not willing to compromise at all.

At process decision block 1206, intermediary server 12 determines whether the “compromise” percentages entered by the vendor and the buyer overlap. In other words, these two “compromise” percentages from the vendor and the buyer together must equal or exceed 100% in order to consummate the sales transaction for the given quantity of business. For example, if the vendor enters a “compromise” percentage of 40 and the buyer enters a “compromise” percentage of 40, these two “compromise” percentages together total 80% and therefore do not overlap. In contrast, if the vendor enters a “compromise” percentage of 50 and the buyer enters a “compromise” percentage of 50, these two “compromise” percentages together total 100% and therefore do overlap.

If intermediary server 12 determines that the “compromise” percentages entered by the vendor and the buyer do not overlap, the new bidding cycle is stopped and the process is completed without consummating a sales transaction for this given quantity of business, at process block 1208. Conversely, if intermediary server 12 determines that the “compromise” percentages entered by the vendor and the buyer do overlap, intermediary server 12 determines the percentage of the price disparity paid by the vendor and the buyer at process blocks 1210-1216.

In particular, at process decision block 1210, intermediary server 12 determines whether the two “compromise” percentages entered by the vendor and the buyer equal 100. If the two “compromise” percentages entered by the vendor and the buyer equal 100, the vendor and the buyer pay the percentage of price disparity that each one entered at process block 1212. For example, if the vendor entered a “compromise” percentage of 60 and the buyer entered a “compromise” percentage of 40, the vendor and the buyer would pay 60% and 40%, respectively, of the price disparity. Therefore, if the price disparity were $10 per quantity of business, the vendor and the buyer would pay $6 and $4, respectively, per quantity of business.

If intermediary server 12 determines the two “compromise” percentages entered by the vendor and the buyer exceed 100, intermediary server 12 determines the percentage of the price disparity to be paid by the vendor and the buyer based on the “compromise” percentages entered by the vendor and the buyer at process block 1214. In particular, how much of the price disparity is paid by a given party depends on their “compromise” percentage in relation to the “compromise” percentage entered by the other party. In one embodiment, the percentage of the price disparity paid by a given party is based on Equation #1:

% of price disparity paid by entity #1=“compromise” percentage of entity #1/(“compromise” percentage of entity #1+“compromise” percentage of entity #2) Equation #1

For example, if the vendor and the buyer both entered “compromise” percentages of 60, then both parties would be 50% each of the price disparity as their “compromise” percentages are equal. In a further example, if the vendor and the buyer enter “compromise” percentages of 80 and 70, respectively, the vendor would pay 53.3% of the price disparity (80/(80+70)), while the buyer would pay 46.7% of the price disparity (70/(70+80)). Intermediary server 12 then adds the percentage of the price disparity paid by the buyer to the buyer's bid price prior to entering this new final bid cycle at process block 1216. Accordingly, the new bidding cycle is complete at process block 1208.

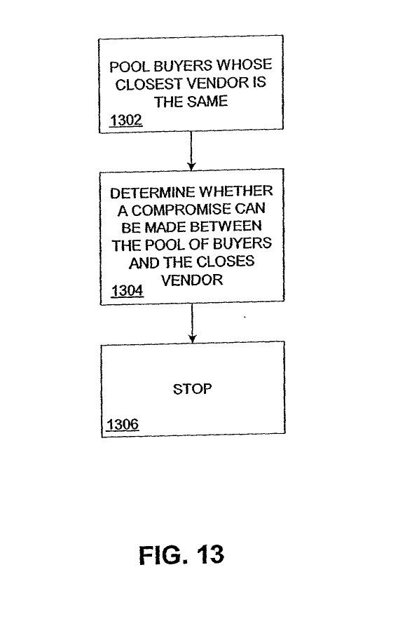

FIG. 13 is a flowchart diagram of another embodiment of the new bidding cycle generated at process block 1112. In particular, FIG. 13 illustrates an embodiment of the new bidding cycle wherein the pooling of buyers, as described above in conjunction with co-pending U.S. patent application Ser. No. 09/560,638 filed on Apr. 28, 2000, titled “Method and Apparatus for Implementing Pooling of Buyers and Vendors based on Lots.”, is incorporated into the meeting of unmet demand. At process block 1302, buyers are pooled together for those whose closest vendor is the same. For example, if both a first buyer and a second buyer have a given vendor as the closest vendor, this given vendor can potentially obtain the unmet demand of business from both buyers if the price disparity between the buyers and the given vendor can be overcome.

At process block 1304, a decision is made as to whether a compromise can be made between a given pool of buyers and a given closest vendor. In one embodiment, there is no negotiation between the buyers and the vendor, as a unilateral decision is made by the vendor. In particular, the given vendor is given the option to lower their asking price to match in order to receive the business from the pool of buyers. In one such embodiment, the largest price disparity within the pool of buyers is disclosed to the vendor, as the price disparity can vary within the striking range with each buyer in the pool.

For example, assuming that there are two buyers in the pool, a first buyer and the vendor may have a price disparity of $5 per quantity of business, while a second buyer and the vendor may have a price disparity of $10 per quantity of business. Therefore, a price disparity of $10 (the largest price disparity) is disclosed to the vendor. Accordingly, if the vendor lowers their bid value by $10 per quantity of business, they will receive all of the business within the buyer pool.

In one embodiment, the new bid value by the vendor applies only to the pool of buyers in this new bidding cycle. In another embodiment, the new bid value by the vendor applies both to the pool of buyers in this new bidding cycle as well as to the buyers in the prior bidding cycles. Accordingly, the buyers in the prior bidding cycles may receive a discount because of the activity of the vendor in this new bidding cycle.

In another embodiment of process block 1304, there is a negotiation process between the given vendor and pool of buyers in order to determine if the price disparity between the two can be resolved. In one such embodiment, the buyers within the pool select a representative to represent them as a group in the negotiation process. Subsequently, the negotiation is between this representative and the given vendor. In another embodiment, the given vendor negotiates with each buyer in the pool individually. In an embodiment, the embodiments of the new bidding cycle illustrated in FIG. 12 is employed as the negotiation process between (1) the representative and the given vendor or (2) the individual buyers in the pool and the given vendor.

Once this negotiation between the vendors and the pool of buyer is finished, the bidding is stopped and this new bidding cycle is competed at process block 1306. As shown, this new bidding cycle gives the two sets of parties an additional limited opportunity in this new bidding cycle to reach a compromise.

In another embodiment, the buyer either agrees to accept or not accept the quantity of business that is within the range prior to any bidding cycles. Accordingly, if the difference is within the range and the buyer has agreed to accept the quantity of business within such a range, the buyer is committed to the quantity of business.

Thus, there are numerous inventions disclosed some of which can be implemented independent of each other. Whereas many alterations and modifications of the present inventions will no doubt become apparent to a person of ordinary skill in the art after having read the foregoing description, it is to be understood that any particular embodiment shown and described by way of illustration is in no way intended to be considered limiting.

Therefore, references to details of various embodiments are not intended to limit the scope of the claims which in themselves recite only those features regarded as essential to the inventions.

What is claimed is:

1. A computer implemented method comprising:
determining that a price for a quantity of business offered by at least one vendor and a price by at least one buyer for the quantity of business do not match during at least one prior bidding cycle in an on-line bidding transaction;
determining a difference between the price by the at least one vendor and the price by the at least one buyer; and
generating a new bidding cycle in the on-line bidding transaction upon determining that the difference is within a range.

2. The computer implemented method of claim 1, wherein the range is based on a percentage of closeness between the price for the quantity of business by the at least one vendor and the price by the at least one buyer for the quantity of business.

3. The computer implemented method of claim 2, wherein generating the new bidding cycle comprises matching the vendor that is closest to the at least one buyer upon determining that the difference between the price by the vendor and the price by the at least one buyer is within the range.

4. The computer implemented method of claim 1, wherein the buyer is anonymous.

5. The computer implemented method of claim 1, wherein the at least one buyer is committed to the quantity of business if the price offered by the at least one vendor is met.

6. The computer implemented method of claim 1, wherein the range is determined subsequent to determining the difference between the price by the vendor and the price by the at least one buyer.

7. The computer implemented method of claim 1, wherein the range is determined prior to any bidding cycle between the vendor and the set of one or more buyers.

8. The computer implemented method of claim 1, wherein the range is determined by the vendor.

9. A computer implemented method comprising:
determining that a quantity of business that a buyer wanted was not met by a set of one or more vendors during at least one prior bidding cycle in an on-line bidding transaction;
selecting one vendor from among the set of one or more vendors that is closest in price for the quantity of business to a price for the quantity of business that is offered by the buyer;
determining a difference between the price by the vendor that is closest and the price by the buyer; and
matching the vendor that is closest to the buyer upon determining that the difference between the price by the vendor and the price by the buyer is within a percentage range.

10. The computer implemented method of claim 9, wherein the percentage range is determined by the one vendor.

11. The computer implemented method of claim 9, wherein the percentage range is determined subsequent to determining the difference between the price by the one vendor and the price by the buyer.

12. The computer implemented method of claim 9, wherein the percentage range is determined prior to any bidding cycle between the one vendor and the buyer.

13. The computer implemented method of claim 9, wherein the percentage range is determined by an intermediary.

14. The computer implemented method of claim 9, wherein the percentage range is based on a price amount of the quantity of business.

15. A computer implemented method comprising:
determining that a price for a quantity of business offered by a set of one or more vendors and a price by a set of one or more buyers for the quantity of business do not match during at least one prior bidding cycle in an on-line bidding transaction;
selecting one vendor from among the set of one or more vendors that is closest in price for the quantity of business to a price for the quantity of business that is offered by the buyer for each buyer in the set of one or more buyers;
determining a difference between the price by the one vendor that is closest and the price by the buyer for each buyer in the set of one or more buyers;
generating a new bidding cycle in the on-line bidding transaction upon determining that the difference is within a range for each buyer in the set of one or more buyers, wherein the generating the new bidding cycle comprises:
generating pools of buyers for each vendor that is closest in price; and
determining whether the price for the vendor is within a percentage range of the price for the pool of buyers for each pool of buyers

16. The computer implemented method of claim 15, wherein the percentage range is determined subsequent to determining the difference between the price by the one vendor and the price by the set of one or more buyers.

17. The computer implemented method of claim 15, wherein the percentage range is determined prior to any bidding cycle between the one vendor and the set of one or more buyers.

18. The computer implemented method of claim 15, wherein the range is determined by the one vendor.

19. The computer implemented method of claim 15, wherein the range is determined by the set of one or more buyers.

20. The computer implemented method of claim 15, wherein the range is determined by an intermediary.
